(19) United States
(12) Patent Application Publication
(10) Pub. No.: US 2026/0067086 A1
(43) Pub. Date: Mar. 5, 2026

(54) USER OR DEVICE AUTHORIZATION ELEMENT IN 4-WAY HANDSHAKE

(71) Applicant: Cisco Technology, Inc., San Jose, CA (US)

(72) Inventors: Ugo M. CAMPIGLIO, Morges (CH); Stephen M. ORR, Wallkill, NY (US); Domenico FICARA, Essertines-Sur-Yverdon (CH); Javier I. CONTRERAS ALBESA, Sant Cugat del Valles (ES); Jerome HENRY, Pittsboro, NC (US); Federico LOVISON, Fontanelle (IT); Juan Carlos ZUNIGA, Montreal (CA)

(21) Appl. No.: 19/224,694

(22) Filed: May 30, 2025

Related U.S. Application Data
(60) Provisional application No. 63/690,936, filed on Sep. 5, 2024.
(60) Provisional application No. 63/772,288, filed on Mar. 14, 2025.

(51) Int. Cl. H04L 9/32; H04L 9/08; H04W 12/0471; H04W 12/06

(52) U.S. Cl. CPC H04L 9/3213; H04L 9/0822; H04L 9/3242; H04W 12/0471; H04W 12/06

(57) ABSTRACT

The present disclosure provides techniques for device authorization using a per-device identifier. A network device authenticates a client device using simultaneous authentication of equals (SAE) with a shared passphrase. After completing association, the network device sends a first message to the client device, comprising an access point (AP)-generated random value to the client device. The network device receives a second message from the client device, comprising a station (STA)-generated random value and an authorization identifier. The network device decrypts the authorization identifier using a session key. In response to determining that the authorization identifier matches an entry in the authorization database, the network device sends a third message confirming authorization of the client device as a trusted entity. The network device receives a fourth message confirming completion of a security key exchange.

### CROSS-REFERENCE TO RELATED APPLICATIONS

This application claims benefit of co-pending U.S. provisional patent application Ser. No. 63/690,936 filed Sep. 5, 2024, and co-pending U.S. provisional patent application Ser. No. 63/772,288 filed Mar. 14, 2025. The aforementioned related patent applications are herein incorporated by reference in their entirety.

### TECHNICAL FIELD

Embodiments presented in this disclosure generally relate to wireless communication. More specifically, embodiments disclosed herein relate to device authorization using a shared authentication credential and a per-device authorization identifier.

### BACKGROUND

In Wi-Fi Protected Access II (WPA2), a shared passphrase is typically used in personal deployments, from which all devices derive a pre-shared key (PSK). In enterprise deployments, personal PSKs (PPSKs) may be used to assign unique keys to different users or devices within the WPA2-based framework. The shared-passphrase approach streamlines the authentication. For example, if an access point (AP) is configured with a list of supported PPSKs, it can attempt to identify the correct key by performing a short brute-force attack against the second message (M2) of the 4-way handshake (part of Extensible Authentication Protocol over Local Area Network (LAN) (EAPOL)) received from a station (STA). However, this approach has limitations on privacy and scalability. If a PSK or PPSK is compromised, any STA using that same key is at risk and may potentially expose the network to unauthorized access. Wi-Fi Protected Access III (WPA3) addresses these security concerns by introducing Simultaneous Authentication of Equals (SAE), which provides resistance to offline brute-force attacks through the use of a zero-knowledge password proof. To support PPSK deployments under WPA3, password identifiers are introduced. These identifiers, sent in cleartext in the first SAE message, allow the AP to identify the correct password to use during authentication.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless network environment configured to perform various aspects of the present disclosure, according to some aspects of the present disclosure.

FIG. 2 depicts an example sequence of interactions between a STA and an AP, where the AP verifies the STA's identity through a received authorization ID encrypted with a session key, according to some embodiments of the present disclosure.

FIG. 3 depicts an example sequence of interactions between a STA and an AP, where the AP verifies the STA's identity through a received authorization ID hashed with an AP-provided random value, according to some embodiments of the present disclosure.

FIG. 4 depicts an example sequence of interactions between a STA and an AP, where the AP verifies the STA's identity through an encrypted authorization ID and an associated authorization token, according to some embodiments of the present disclosure.

FIG. 5A depicts an example method performed by an AP, where an authorization ID is received from a STA and the AP verifies the STA's identity using the authorization ID during a 4-way handshake process, according to some embodiments of the present disclosure.

FIG. 5B depicts an example method performed by a STA for transmitting an authorization ID to an AP for identity verification during a 4-way handshake process, according to some embodiments of the present disclosure.

FIG. 6A depicts an example method performed by an AP, where a hashed value for authorization is received from a STA and the AP verifies the STA's identity using the hashed value during a 4-way handshake process, according to some embodiments of the present disclosure.

FIG. 6B depicts an example method performed by a STA for transmitting a hashed value for authorization to an AP for identity verification during a 4-way handshake process, according to some embodiments of the present disclosure.

FIG. 7A depicts an example method performed by an AP, where an encrypted authorization ID and an associated authorization token are used to verify an STA's identity during a 4-way handshake process, according to some embodiments of the present disclosure.

FIG. 7B depicts an example method performed by a STA for transmitting an encrypted authorization ID and a session-based authorization ticker derived from an authorization token to an AP for identity verification during a 4-way handshake process, according to some embodiments of the present disclosure.

FIG. 8 is a flow diagram depicting an example method for authorization verification using an authorization ID encrypted with a session key, according to some embodiments of the present disclosure.

FIG. 9 is a flow diagram depicting an example method for authorization verification using a hashed authorization ID generated with an AP-provided random value, according to some embodiments of the present disclosure.

FIG. 10 is a flow diagram depicting an example method for authorization verification using an encrypted authorization ID and an associated authorization token, according to some embodiments of the present disclosure.

FIG. 11 depicts an example network device configured to perform various aspects of the present disclosure, according to some aspects of the present disclosure.

FIG. 12 depicts an example client device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including authenticating, by a network device, a client device using simultaneous authentication of equals (SAE) with a shared passphrase, after completing association, sending, by the network device to the client device, a first message comprising an access point (AP)-generated random value, receiving, by the network device from the client device, a second message comprising a station (STA)-generated random value and an authorization identifier, where the authorization identifier is encrypted using a session key, decrypting, by the network device, the authorization identifier using the session key, determining, by the network device, whether the authorization identifier matches an entry in an authorization database of the network device, in response to determining that the authorization identifier matches an entry in the authorization database, sending, by the network device, a third message confirming authorization of the client device as a trusted entity, and receiving, by the network device from the client device, a fourth message confirming completion of a security key exchange.

One embodiment presented in this disclosure provides a method, including authenticating, by a network device, a client device using simultaneous authentication of equals (SAE) with a shared passphrase, after completing association, generating, by the network device, an AP-generated authorization random value, sending, by the network device to the client device, a first message comprising an access point (AP)-generated random value and the AP-generated authorization random value, receiving, by the network device from the client device, a second message comprising a station (STA)-generated random value and a STA-generated hashed authorization identifier, decrypting, by the network device, the STA-generated hashed authorization identifier using a session key, determining, by the network device, whether the STA-generated hashed authorization identifier matches an entry in a precomputed hash database associated with a plurality of authorization identifiers known by the network device, in response to determining that the STA-generated hashed authorization identifier matches an entry in the precomputed hash database, sending, by the network device, a third message confirming authorization of the client device as a trusted entity, and receiving, by the network device from the client device, a fourth message confirming completion of a security key exchange.

One embodiment presented in this disclosure provides a method, including authenticating, by a network device, a client device using simultaneous authentication of equals (SAE) with a shared passphrase, sending, by the network device to the client device, a first message comprising a first access point (AP)-generated random value, receiving, by the network device from the client device, a second message comprising a first station (STA)-generated random value, an authorization identifier, and an authorization ticket, decrypting, by the network device, the authorization identifier using a session key, retrieving, by the network device, an authorization token associated with the authorization identifier from a database, computing, by the network device, an AP-authorization key by applying a hash function to the authorization token and the session key, decrypting, by the network device, the authorization ticket using the AP-authorization key to extract a second STA-generated random value, determining, by the network device, whether the second STA-generated random value matches the first STA-generated random value included within the second message, and in response to determining that the second STA-generated random value matches the first STA-generated random value, sending, by the network device, a third message comprising the first AP-generated random value and a second authorization ticket, where the second authorization ticket is generated by encrypting the first AP-generated random value using the AP-authorization key.

### EXAMPLE EMBODIMENTS

WPA2-PSK is a security protocol that uses a shared passphrase to derive a PSK. The PSK is then used during the 4-way EAPOL handshake to generate PTKs, which encrypt traffic between an AP and a client device. In typical WPA2-personal deployments, all devices use the same PSK derived from the shared passphrase. However, in some deployments, a variation known as PPSKs may be used to assign unique keys to individual users or devices for granular access control and policy enforcement. When receiving an authentication request from a STA, the AP, knowing the shared passphrase (e.g., in WPA2-personal), can authenticate devices by deriving the PSK and completing the EAPOL handshake. The AP may be provisioned with a list of supported PPSKs and can run a short brute-force attack on the M2 of the EAPOL handshake from the STA to determine which PPSK is being used. This allows the AP to authenticate the STA and apply specific policies or group memberships.

However, WPA2 has significant limitations on privacy and scalability. In WPA2-personal, if the shared passphrase is compromised, the entire network is at risk, as an attacker could gain unauthorized access to all devices using the same PSK. While PPSKs provide user-level isolation, the brute-force approach used by the AP to identify PPSKs highlights the inherent vulnerability of WPA2 to offline brute-force attacks by malicious actors. An attacker could capture the EAPOL handshake messages and perform a similar brute-force attack to determine the PPSK being used by a specific STA.

WPA3-Personal addresses many of the limitations of WPA2 by introducing SAE, which provides a more secure key exchange protocol. To support deployments where different users or devices use unique passwords (e.g., PPSKs), WPA3 optionally introduces the use of password identifiers. In such configurations, each user or group may have a unique password, and a corresponding password identifier is associated with that password. The password is not transmitted over the air. Instead, during the SAE exchange, the STA includes a password identifier in the first SAE message. The identifier serves as a reference point for the AP to determine which password to use for authentication. The use of password identifiers improves system security by preventing offline brute-force attacks. Even if a malicious attacker intercepts the first SAE message, it cannot derive the password from the identifier, as the identifier itself does not contain any cryptographic material.

However, password identifiers introduce a new privacy issue. The password identifier is sent in clear text. While the identifier does not reveal the password itself, it can still compromise privacy. Since the identifier is linked to a specific user or group, an attacker who captures the identifier may determine which user or group is connecting to the network. Over time, repeated interception of the same identifier allows an attacker to correlate multiple sessions to the same device or user. This undermines the privacy-enhanced techniques introduced in IEEE 802.11bh and 802.11bi, which are designed to anonymize management frames and suppress persistent device identifies.

One potential method to address the privacy issue of clear text password identifiers is to encrypt the identifier directly in the first SAE message. However, this approach may raise new challenges. For example, encrypting the identifier relies on a shared key or cryptographic material established before the SAE exchange, which further complicates the authentication process and may introduce latency that potentially impacts the overall network performance. Moreover, if the encryption mechanism is not carefully designed, it could still be vulnerable to certain attacks, such as replay attacks or man-in-the-middle (MiTM) attacks.

Embodiments of the present disclosure provide a more secure and efficient approach for APs and non-APs to establish a wireless connection, including the Wi-Fi authentication, association, and authorization processes. Within the disclosed embodiments, STAs securely authenticate to the AP using a shared passphrase, associate with the network, and perform fine-grained authorization based on device-specific policies.

Embodiments of the present disclosure decouple the authentication process (SAE) from the authorization process (4-way EAPOL handshake). By decoupling authentication from authorization, a shared passphrase can be used for authentication (instead of using the password plus password identifier model in WPA3). During the 4-way handshake, an encrypted authorization element is added within the handshake messages to enable STA-specific authorization. The element includes an authorization ID, which the AP uses to verify the STA's identity and apply device-specific policies or group memberships. Since the authorization ID is encrypted within the handshake process (e.g., by the PTK or other encrypting keys), user privacy is preserved without introducing additional complexity or performance overhead. In addition, the authorization element can be extended to enable consistent grouping and policy application across both WPA3-PSK (passphrase-based) and WPA3-Enterprise (802.1x-based) STAs. Specifically, the authorization ID within the element allows a passphrase-based STA to be assigned to the same group or virtual local area network (VLAN) as a set of 802.1x-based STAs. For example, by transmitting an encrypted authorization ID during the 4-way handshake or via a protected action frame, a passphrase-based STA can signal its intended group identity to the AP. The AP can then associate that STA with an existing group policy configuration (e.g., access privilege or VLAN assignment) shared with 802.1x-based STAs. This approach allows for unified access control in mixed deployments, such as dormitory or enterprise environments, without modifying the 802.1x authentication flow or relying solely on password identifiers.

In one embodiment, the authorization ID may be encrypted using the pairwise transient key (PTK) generated by the STA, within M2 of the EAPOL handshake. The AP decrypts the authorization ID using its own key encryption key (KEK) (e.g., a subkey of the PTK) and verifies it against a list of known IDs to determine the STA's identity and apply the appropriate policies.

In another embodiment, the authorization ID may be included within a key data encapsulation (KDE) element, which is encrypted (e.g., using the KEK) and transmitted during the handshake. The AP then decrypts the KDE to retrieve the authorization ID and uses it for policy enforcement.

In another embodiment, the STA may not send the authorization ID directly. Instead, it may hash a new ad-hoc nonce (represented by Authz-ID-ANonce) using the authorization ID as part of the hash computation. The hashed nonce may then be sent in an encrypted KDE. The AP may decrypt the KDE and compare the received hash with pre-computed hashes of all known authorization IDs. If a match is found, the AP identifies the STA as a trusted entity and applies proper policies. This approach protects against MiTM attacks, which rely on intercepting the authorization ID to launch targeted attacks.

In another embodiment, the STA is provisioned with an authorization ID and an authorization token either through out-of-band (OOB) mechanisms or in-band via a protected action frame. After receiving EAPOL M1, the STA derives a temporary authorization key using the current session key (e.g., KEK) and sends the encrypted authorization ID and an authorization ticket in EAPOL M2. The AP decrypts the authorization ID, retrieves the corresponding authorization token, and verifies the authorization ticket. If the verification succeeds, the AP sends another encrypted authorization ticket to the STA in EAPOL M3, which the STA validates before completing the handshake. The disclosed embodiment adds another layer of protection against MiTM attacks, where a temporary authorization key is derived using the current session key and an OOB (or in-band) provisioned authorization token. This approach ensures that even if an attacker intercepts the authorization ID, it cannot reuse it for future sessions.

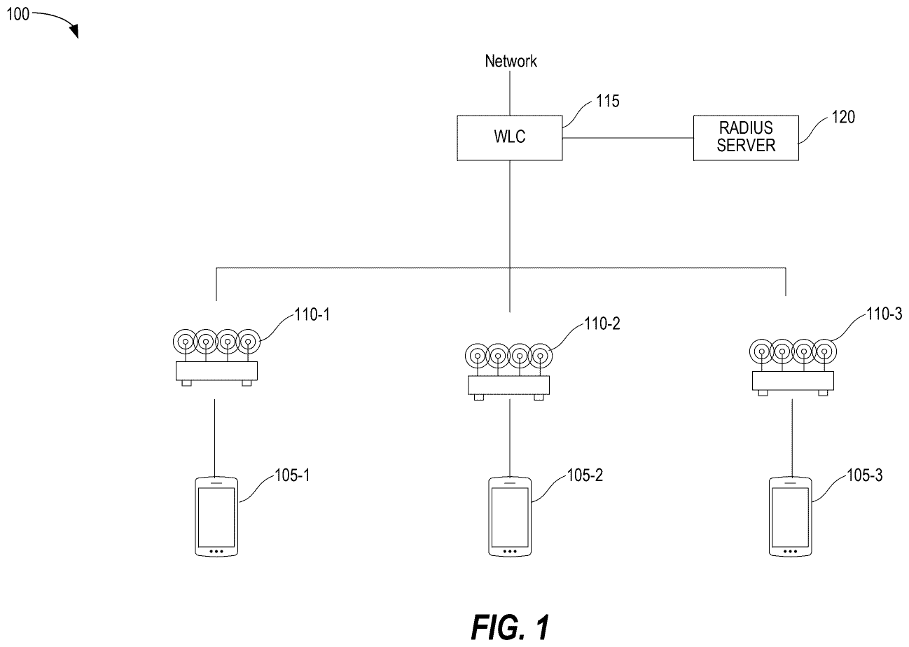

FIG. 1 depicts an example wireless network environment 100 configured to perform various aspects of the present disclosure, according to some aspects of the present disclosure.

As depicted, the example environment 100 includes three stations (STAs) 105-1, 105-2, and 105-3, each connected to an access point (AP) 110. As illustrated, STA 105-1 connects to AP 110-1, STA 105-2 connects to AP 110-2, and STA 105-3 connects to AP 110-3. All three APs are connected to a wireless local area network (LAN) controller (WLC) 115. The WLC 115 then connects to a broader network infrastructure, such as a router or cloud-based management system. In one embodiment, the WLC 115 manages network configuration, roaming, and load balancing across the network.

Additionally, as depicted, the WLC 115 further connects to a radius server 120, which handles authentication, authorization, and accounting (AAA) for devices 105 connecting to the network. The SAE is typically handled by the AP 110. However, in some embodiments, the WLC 115 and radius server 120 may offload certain tasks (e.g., policy enforcement or key management) from the APs 110 to improve the overall performance.

In a WPA3 network, the three depicted APs 110-1, 110-2, and 110-3 may belong to the same Wi-Fi network. One example is the airport Wi-Fi network, where multiple APs 110 provide coverage across a large area. In this embodiment, each STA 105-1, 105-2, or 105-3 connects to one of the APs but is part of the same extended service set (ESS). If each STA 105 belongs to a different group (e.g., Group A, Group B, and Group C), in a WPA3-Personal network using password identifiers, the authentication process involves a unique identifier and password for each group. For example, when STA 105-1 attempts to connect to AP 1, it uses a unique identifier (e.g., GroupA_ID) and password (e.g., GroupA_Password) associated with its group during the SAE process. The STA 105-1 sends the identifier (e.g., GroupA_ID) in cleartext in the first SAE Commit message. The AP verifies the identifier and uses the corresponding password (e.g., GroupA_Password) to complete the SAE exchange. The verification ensures that only authorized devices can connect. The approach under WPA3 with password identifiers allows the network to enforce group-specific policies (e.g., virtual local area network (VLAN) assignments, bandwidth limits, or firewall rules) based on the identifier. For example, GroupA_ID may be associated with a high-priority VLAN for a corporate client, whereas GroupB_ID may be associated with a guest network with restricted bandwidth. However, as discussed above, the cleartext transmission of the password ID introduces a privacy concern, as it may be intercepted and linked to specific users or groups. For example, an attacker capturing the identifier GroupA_ID repeatedly could determine that the STA belongs to a specific group, which may potentially expose sensitive information about the users or their activities.

Embodiments of the present disclosure address the privacy concerns inherent in WPA3's cleartext identifier transmission by decoupling authentication from authorization. More specifically, in the disclosed embodiments, authentication occurs through standard SAE using a shared passphrase, followed by authorization determined through encrypted policy elements exchanged during the EAPOL 4-way handshake, instead of using cleartext transmission.

When a STA connects to the network, it first completes SAE authentication using the shared passphrase, identical to WPA3-Personal or WPA3-PSK operation. However, unlike password identifiers that are sent in cleartext during SAE, the authorization process occurs separately within the encrypted EAPOL handshake. In the example environment 100, each STA 105-1, 105-2, or 105-3 is provisioned with a unique authorization ID that defines its group membership or policy privileges. After STA 105-1 authenticates with AP 110-1 using the shared passphrase, the STA 105-1 includes its authorization ID within the EAPOL M2. In one embodiment, the authorization ID may be encrypted using the session keys like the KEK or encapsulated in a KDE element. In other embodiments, the authorization ID itself may not be transmitted directly. Instead, a hashed value derived from the authorization ID and a nonce, or a temporary authorization ticket derived from an OOB (or in-band) provisioned authorization token, may be included in the M2. This approach allows the STA 105-1 to prove knowledge of the authorization ID without transmitting it explicitly.

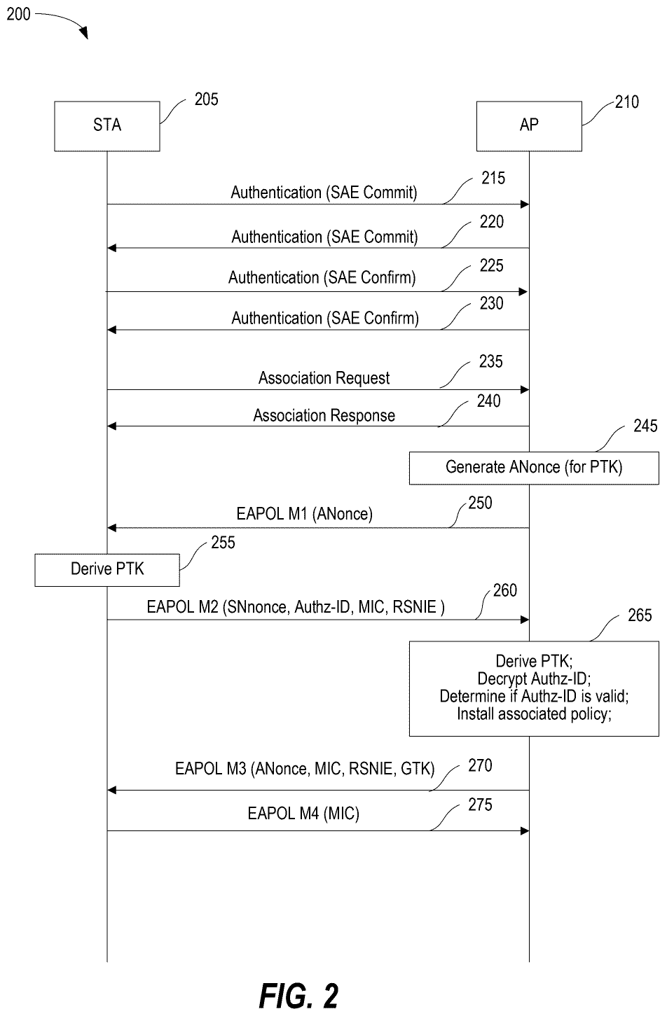

In embodiments where the authorization ID is shared explicitly within the M2, the AP 110-1, upon receiving M2, may decrypt the element using the KEK and compare the extracted ID against its policy database. When working with hashed values, the AP compares the received hash against a set of precomputed values generated from known authorization IDs. In embodiments where authorization tickets are used, the AP verifies the cryptographic signature against the STA's provisioned token. Additional details about the authorization ID sharing mechanism and STA identity verification process are discussed below with reference to FIGS. 2-4.

In some embodiments, particularly in enterprise environments, the decryption of authorization and verification of STA identities may be offloaded from the AP to the network infrastructure components. For example, the radius server 120 may handle the cryptographic validation of authorization tickets or hashed values. For example, when STA 105-3 connects, the AP 110-3 may forward its received authorization ticket (e.g., from the STA 105-3) to the radius server 120, which checks it against provisioned tokens and returns the applicable policies. The WLC 115 may coordinate policy enforcement across APs 110 and cache authorization results to optimize the relevant roaming process (e.g., STA 105-1 roaming from AP 110-1 to AP 110-3).

FIG. 2 depicts an example sequence of interactions 200 between a STA 205 and an AP 210, where the AP 210 verifies the STA's identity through a received authorization ID encrypted with a session key, according to some embodiments of the present disclosure.

The STA 205 may correspond to STA 105-1, 105-2, or 105-3 as depicted in FIG. 1, and the AP 210 may correspond to AP 110-1, 110-2, or 110-3 as depicted in FIG. 1. When STA 205 attempts to connect to AP 210, the STA 205 first initiates the SAE, which is a password-authentication key exchange mechanism used to mutually verify possession of a shared authentication credential (e.g., passphrase). When the STA 205 is part of an ESS that includes multiple STAs, each of the STAs may use the same shared passphrase during the SAE process to authenticate within the AP 210.

As depicted, SAE involves the exchange of four authentication messages between STA 205 and AP 210: (1) a SAE Commit message 215 from the STA 205 to the AP 210; (2) a SAE Commit message 220 from AP 210 to STA 205; (3) a SAE Confirm message 225 from the STA 205 to the AP 210; and (4) a SAE Confirm message 230 from the AP 210 to the STA 205. More specifically, in the SAE Commit message 215, the STA 205 includes cryptographic elements derived using the shared passphrase. For elliptic curve cryptography (ECC) groups, the message 215 includes a scalar value and an elliptic curve point derived from the scalar. For finite field cryptography (FFC) groups, the message 215 includes a Diffie-Hellman exponent and the corresponding group element. The AP 210 responds with its own SAE Commit message 220. The message 220 contains similar cryptographic elements constructed through the same mathematical operations by the AP but using the AP's independently generated nonce values. For ECC groups, the message 220 includes the AP's scalar and elliptic curve point, and for FCC groups, the message 220 includes the AP's Diffie-Hellman exponent and computed group element. Following the exchange, both devices receive sufficient information to independently compute a shared secret used to derive the pairwise master key (PMK).

Once the shared secret is computed, as depicted, the STA 205 transmits a SAE Confirm message 225 to the AP 210. The message 225 includes a cryptographic confirmation value computed using the shared secret (which is derived from the exchanged commit elements), along with the STA's own randomly generated values. The confirmation value allows the STA 205 to provide that it possesses the correct shared secrete, without revealing the secret itself.

The AP 210 also computes a corresponding confirmation value using the shared secret it has derived and the AP's locally generated nonces. Upon receiving the SAE Confirm message 225 from the STA 205, the AP 210 compares the received confirmation value against its own computed value to verify whether the STA possesses the correct shared secret. The AP then replies with its own SAE Confirm message 230, including its own confirmation value. Upon receiving the message 230, the STA 205 performs a similar comparison using the AP's confirmation value and its locally derived secret. If the confirmation values match, the STA 205 concludes that the AP 210 also possesses the correct shared secret. At this point, mutual authentication is established, and both parties (AP 210 and STA 205) generate an identical PMK, which will be used to generate session-specific keys during the subsequent 4-way handshake.

Following successful SAE, the process moves to the association phase. As depicted, the STA 205 transmits an Association Request frame 235 to the AP 210. In some embodiments, the Association Request frame 235 may include information related to the STA's supported capabilities, such as supported data rates, security protocols, and requested features. The message 235 formally requests to join the BSS managed by the AP 210. The AP then processes the request and responds with an Association Response frame 240. The response may include the association status code, which indicates whether the request is accepted or rejected. If the request is accepted, the response may further include a unique Association ID (AID) assigned to the STA 205.

Once the association is complete, the EAPOL 4-way handshake begins to establish encryption keys and verify authorization. As depicted by block 245, the AP 210 generates a random value for PTK generation. The random value may also be referred to as the ANonce, and it serves as part of the input to derive the PTK. The AP 210 includes the ANonce in EAPOL M1 250, which is transmitted to the STA 205.

Upon receiving M1, as depicted by block 255, the STA generates its own random number (also referred to in some embodiments as the SNonce), and uses the random number together with the ANonce to derive the PTK. More specifically, the PTK is generated by using a pseudo-random function (PRF) that takes the PMK as input, along with the concatenation of the AP media access control (MAC) address and the STA MAC address, as well as the concatenation of the ANonce and the SNonce. The output of the key derivation function is the PTK, which can be divided into multiple subkeys, including a key confirmation key (KCK) (e.g., used for EAPOL-Key message integrity checks), a key encryption key (KEK) (e.g., used for encrypting key material in EAPOL-Key frames), and a temporary key (TK) (e.g., used for encrypting actual wireless data frames).

Once the PTK is developed, the STA 205 constructs and transmits EAPOL M2 260 to the AP 210. The message 260 includes the generated SNonce, a message integrity code (MIC) computed using the KCK, the robust security network information element (RSNIE), and the STA's authorization ID. In one embodiment, the authorization ID may be encrypted directly using the KEK. In another embodiment, the authorization ID may be encapsulated within a KDE, and the KDE is encrypted using the KEK.

As depicted by block 265, the AP 210, upon receiving EAPOL M2, computes the PTK using the included SNonce, the AP's previously generated ANonce, the MAC addresses of the STA and AP, and the PMK. The AP-generated PTK includes subkeys such as a KCK and a KEK. The AP 210 then uses the KEK to decrypt the received authorization ID (directly or via the KDE) and compare it against a list of known valid authorization IDs stored locally or remotely via a backend service (e.g., the radius server 120 of FIG. 1). If a match is found, the STA 205 is identified as an authorized entity, and the AP 210 applies the associated policy or group attributes to the session. Following that, the AP 210 transmits EAPOL M3 270 to the STA 205. The message 270 includes the original ANonce, a MIC computed using the KCK, the RSNIE, and the group temporal key (GTK) (optional). The message 270 indicates that the AP 205 has successfully authenticated and authorized the STA 205. The STA 205 then verifies the MIC in M3 270, installs the computed PTK and GTK, and sends EAPOL M4 275 to the AP 210. The M4 275 includes a MIC that confirms the successful completion of the 4-way handshake and installation of encryption keys on the STA side. Following that, secure bidirectional communication is established between the STA 205 and AP 210.

In embodiments where the authorization ID decrypted by the AP does not match any known or valid entry in the authorization database, the AP 210 may terminate the session by sending a deauthentication frame to the STA 205. The message denies (or revokes) network access to the STA 205. Since the authentication (SAE) is decoupled from the authorization, this approach allows the network operator to block specific devices or users without changing the shared passphrase for all other devices in the ESS.

In some embodiments, instead of rejecting the STA 205 outright, the AP 210 may allow the EAPOL handshake to complete by proceeding with the transmission of EAPOL M3 270 and accepting EAPOL M4 275 from the STA. However, the AP 210 may assign the STA 205 to a group with limited network access, such as a guest or default VLAN. This solution supports onboarding new users without preloading IDs on the AP. In such embodiments, the STA may be permitted to send its authorization ID in a later message, such as the EAPOL M4 or another protected action frame. Through this approach, the AP gathers credentials for a new user and initiates a registration flow for the new user after basic connection is established.

In some embodiments, when a radius server (e.g., 120 of FIG. 1) is used as part of the network infrastructure, the operation of verifying whether the decrypted authorization ID matches a known entry may be offloaded to the radius server. In such embodiments, the AP 210 may forward the decrypted authorization ID to the radius server, which then evaluates the ID against a central database and returns an authorization result to the AP 210. The result may indicate whether the ID is valid and, if so, the corresponding policy or group assignment for STA 205. The authorization result may be cached by a WLC (e.g., 115 of FIG. 1) associated with the AP 210 to support future roaming activities. For example, when the STA 205 roams across APs within the same ESS, the authorization decisions may be handled by the WLC without re-querying the radius server (e.g., 120 of FIG. 1).

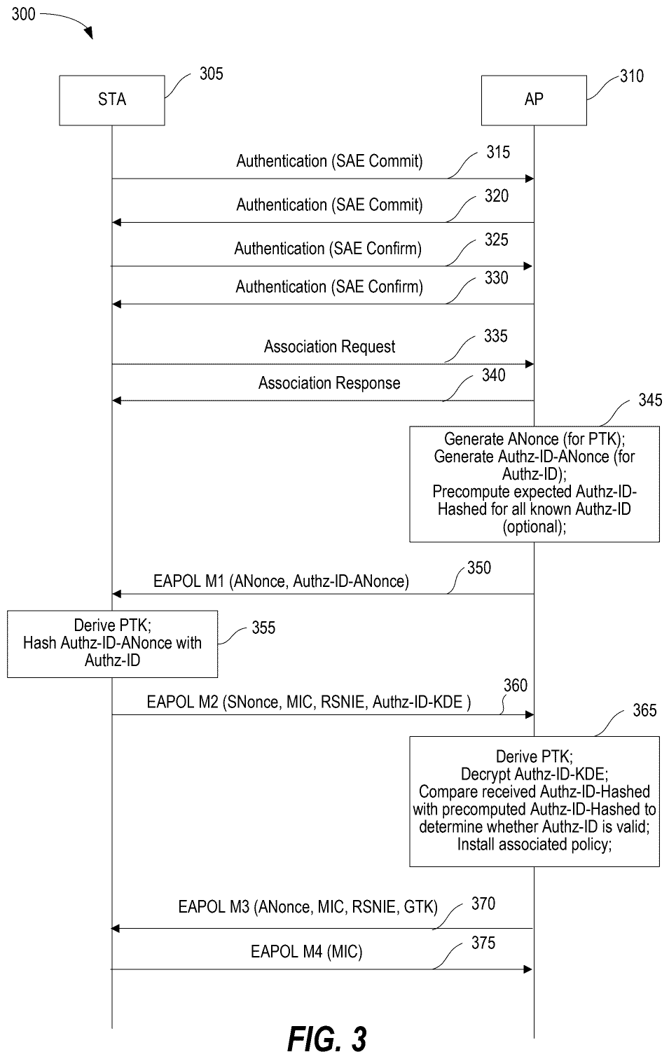

FIG. 3 depicts an example sequence of interactions 300 between a STA 305 and an AP 310, where the AP 310 verifies the STA's identity through a received authorization ID hashed with an AP-provided random value, according to some embodiments of the present disclosure.

The STA 305 may correspond to STA 105-1, 105-2, or 105-3 as depicted in FIG. 1, and the AP 310 may correspond to AP 110-1, 110-2, or 110-3 as depicted in FIG. 1. As depicted, the exchange begins with SAE, during which four authentication messages are exchanged using a shared passphrase. These include (1) a SAE Commit message 315 from the STA 305 to the AP 310; (2) a SAE Commit message 320 from AP 310 to STA 305; (3) a SAE Confirm message 325 from the STA 305 to the AP 310; and (4) a SAE Confirm message 330 from the AP 310 to the STA 305. The exchange mutually authenticates the parties and generates a PMK.

Following successful SAE, the STA 305 initiates association by transmitting an Association Request frame 335 to the AP 310. In response, the AP 310 returns an Association Response frame 340, indicating whether the request is accepted or rejected.

Once the association is established, the EAPOL 4-way handshake begins to establish encryption keys and verify the STA's authorization. As depicted by block 345, the AP 310 generates two random values: an ANonce for PTK derivation and a random value specific for authorization (also referred to as the Authz-ID-ANonce). The AP 310 may also precompute a set of expected hashed authorization values corresponding to known valid authorization IDs, using the same Authz-ID-ANonce. The precomputed hashed values may be saved locally by the AP 310 or remotely in a central database.

As illustrated, the AP 310 transmits EAPOL M1 350 to the STA 305. The message 350 includes the ANonce and the Authz-ID-ANonce. Upon receiving M1, as depicted by block 355, the STA 305 generates its own random value, SNonce, and derives the PTK using the PTM, the received ANonce, and the MAC addresses of both the STA 305 and AP 310. The STA 305 also computes a hashed authorization value (also referred to as the Authz-ID-Hashed) to be used in the authorization process. The value is derived by concatenating the STA's locally stored authorization identifier (e.g., Authz-ID) with the AP-provided authorization-specific nonce (e.g., Authz-ID-ANonce), and then applying a cryptographic hash function. The operation may be represented as follows:

$$Authz ‐ ID ‐ Hashed = Hash ( Authz ‐ ID \vert Authz ‐ ID ‐ ANonce )$$

The hashed value (e.g., the Authz-ID-Hashed) is then encapsulated in a new authorization element, such as a KDE, and encrypted using the KEK derived from the PTK. The encrypted element is then included in EAPOL M2 sent to the AP 310.

As depicted, the STA 305 transmits EAPOL M2 360 to the AP 310. The M2 includes the SNonce, a MIC, the RSNIE, and the encrypted authorization KDE (also referred to as the Authz-ID-KDE). As depicted by block 365, the AP 310 then derives the PTK using the same inputs, including the PMK, ANonce, SNonce, and MAC addresses. The AP 310 then decrypts the authorization KDE using the KEK and extracts the hashed authorization value (also referred to as the Authz-ID-Hashed). The AP 310 compares the received hashed value against its precomputed set of valid hashed values (e.g., for known authorization IDs) to determine whether there is a match. In this embodiment, the STA 305 proves the knowledge of a valid authorization ID without transmitting the authorization ID explicitly. If a match is found, the AP 310 applies the associated access policy or group configuration. Following that, the AP 310 transmits EAPOL M3 370 to the STA 305. The message 370 includes the ANonce, a new MIC, the RSNIE, and a GTK (optional). The STA 305 responds with EAPOL M4 375, which includes a MIC confirming completion of the 4-way handshake and successful key installation.

In embodiments where the AP 310 is unable to find a match for the hashed authorization value (e.g., extracted from the decrypted KDE in M2), this indicates that the STA does not possess a valid or pre-registered authorization identifier recognized by the network. In such embodiments, the AP 310 may interpret this as an unauthorized attempt or an indication that the device's access has been revoked. To enforce strict access control, in one embodiment, the AP 310 may transmit a deauthentication frame to the STA 305, terminating the session and denying the STA 305 access to the network. In other embodiments, even if no match is found, the AP 310 may still proceed with sending EAPOL M3 to the STA and accepting M4 in return. In these configurations, the AP 310 may complete the 4-way handshake but place the STA 305 in a restricted group (e.g., guest or default VLAN) with limited network access. This mechanism supports onboarding workflows and allows newly connecting devices to gain temporary connection for the purpose of registration or provisioning. In such embodiments, the STA 305 may transmit its authorization ID again in M4 or a separate protected action frame sent after the handshake.

When a radius server (e.g., 120 of FIG. 1) is used, in some embodiments, the AP may offload the authorization ID verification to the server. Specifically, upon receiving EAPOL M2 360, the AP 310 may forward the Authz-ID-ANonce along with the decrypted authorization element (e.g., the extracted Authz-ID-Hashed from the KDE) to the radius server. The server may then perform the hash comparison using its database of known authorization IDs and compute the expected hashed values based on the provided Authz-ID-ANonce. Based on the comparison result, the radius server returns an authorization decision to the AP 310, indicating whether the hashed value corresponds to a valid and recognized STA. The response may also include policy attributes associated with the identifier, including but not limited to, access privileges, group membership, VLAN assignment, or onboarding status. This architecture allows for centralized control and consistent policy enforcement across distributed APs. In some embodiments, to further improve performance in roaming scenarios, the authorization result returned by the radius server may be cached by a WLC (e.g., 115 of FIG. 1) associated with the AP 310. When receiving a roaming request from the same STA 305, the WLC may handle the authorization decisions efficiently without re-querying the radius server (e.g., 120 of FIG. 1).

The disclosed example sequence of interactions 300 between the AP and STA provides protection against man-in-the-middle (MiTM) attacks in which an adversary, who may possess the shared passphrase, attempts to identify or extract a user's authorization identifier. In the disclosed embodiments, instead of transmitting the authorization ID directly, the STA 305 transmits a hashed value (e.g., Authz-ID-Hashed), which is generated by applying a hash function to its authorization ID in combination with a one-time, AP-generated random value (e.g., Authz-ID-ANonce). Because the Authz-ID-ANonce is generated uniquely by the AP 310 for each session and not reused across sessions, the resulting hashed authorization value changes each time the STA 305 initiates a connection. As a result, even if an attacker knows the shared passphrase and captures EAPOL M2, the attacker cannot correlate the encrypted hash back to a specific device or user authorization ID.

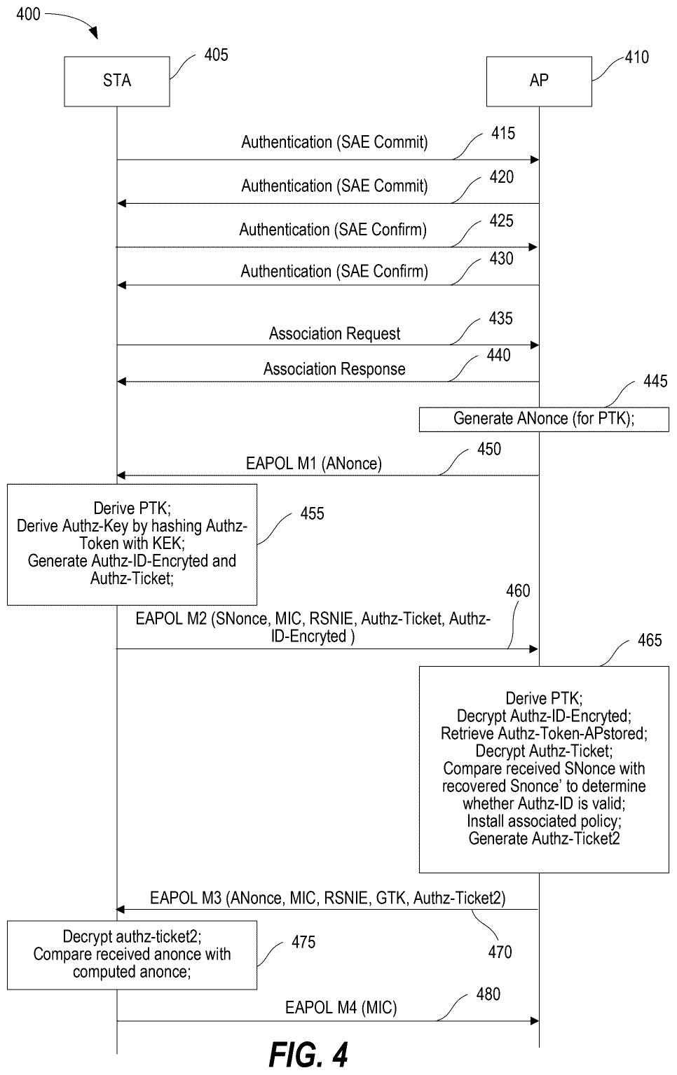

FIG. 4 depicts an example sequence of interactions 400 between a STA and an AP, where the AP verifies the STA's identity through an encrypted authorization ID and an associated authorization token, according to some embodiments of the present disclosure.

The STA 405 may correspond to STA 105-1, 105-2, or 105-3 as depicted in FIG. 1, and the AP 410 may correspond to AP 110-1, 110-2, or 110-3 as depicted in FIG. 1. In this embodiment, each STA 405 is linked to a unique authorization ID (also referred to as the Authz-ID) and a corresponding authorization token (also referred to as the Authz-Token). The provisioning of the Authz-ID and Authz-Token may occur either through an OOB mechanism (e.g., secure enrollment) or in-band via a separate action frame exchanged after initial authentication (SAE). The action frame may be protected using session keys or public key infrastructure (PKI). The inclusion of the authorization token prevents permanent theft of the authorization ID by a MiTM attacker. Even if a passive or active attacker captures protocol messages in one session, the attacker cannot reuse the same authorization information in future sessions, as the authorization token is used in combination with session-specific material (e.g., KEK) to derive a per-session authorization key (also referred to as Authz-Key).

As depicted, when STA 405 attempts to connect to AP 410, the STA first initiates the SAE handshake for authentication using a shared passphrase. The messages exchanged include (1) a SAE Commit message 415 from the STA 405 to the AP 410; (2) a SAE Commit message 420 from AP 410 to STA 405; (3) a SAE Confirm message 425 from the STA 405 to the AP 410; and (4) a SAE Confirm message 430 from the AP 410 to the STA 405. Following the completion of the SAE handshake, a PMK is generated.

Following the SAE handshake, the STA 405 transmits an Association Request frame 435 to the AP 410. The AP 410 responds with an Association Response frame 440 to complete the association process. After that, as illustrated, the EAPOL 4-way handshake begins, where the AP generates a random value (also referred to as the ANonce) (as depicted by block 445). The AP 410 then includes the ANonce within the EAPOL M1 450 and transmits the message to the STA 405.

As depicted by block 455, upon receiving EAPOL M1, STA 405 derives a PTK using the PMK, the received ANonce, a locally generated SNonce, and the MAC addresses of both the STA 405 and the AP 410. The PTK includes a KEK used for encrypting key data. Additionally, the STA 405 further derives an authorization key (also referred to as the Authz-Key or Authz-Key-STADerived) using a cryptographic hash function over the KEK and its locally stored authorization token (also referred to as the Authz-Token). The operation may be represented as follows:

$$Authz ‐ Key = Hash ( KEK \vert Authz\_Token )$$

Moreover, the STA 405 encrypts its locally stored authorization ID using the KEK, represented as follows:

$$Authz ‐ ID ‐ Encrypted = Encrypt ( Authz ‐ ID , KEK )$$

Using the derived Authz-Key, the STA further generates an authorization ticket (also referred to as the Authz-Ticket) by encrypting the locally generated SNonce, represented as follows:

$$Authz ‐ Ticket = Encrypt ( SNonce , Authz ‐ Key )$$

As depicted, the STA 405 transmits EAPOL M2 460 to the AP 410. The M2 includes the SNonce (generated by the STA), MIC, RSNIE, encrypted authorization ID (also referred to as the Authz-ID-Encrypted), and generated authorization ticket (also referred to as the Authz-ticket).

As depicted by block 465, the AP 410 derives the PTK using the same inputs as the STA 405. The KEK, which is a subkey of the PTK, is then used by the AP to decrypt the received Authz-ID-Encrypted, and therefore recovers the authorization ID (e.g., the Authz-ID) stored by the STA 405. The decryption process may be represented as follows:

$$Authz\_ID = Decrypt ( Authz ‐ ID ‐ Encrypted , KEK )$$

Using the recovered Authz-ID, the AP 410 retrieves the corresponding authorization token (also referred to as the Authz-Token-APstored) from its internal database or via a radius server (e.g., 120 of FIG. 1). With the KEK and retrieved token, the AP 410 computes its own version of the Authz-Key, represented as follows:

$$Authz ‐ Key ‐ APDerived = Hash ( KEK \vert Authz\_Token \_APStored )$$

The AP 410 then decrypts the received Authz-ticket using this key (e.g., the Authz-Key-APDerived) to recover SNonce′ (also referred to as SNonce-APDerived or computed SNonce′), represented as follows:

$$SNonce ‐ APDerived = Decrypt ( Authz ‐ Ticket , Authz ‐ Key ‐ APDerived )$$

The AP 410 compares the recovered SNonce′ to the SNonce explicitly included in M2. If the values do not match, this may indicate a MiTM or tempering attempt, and the AP 410 may respond by sending a deauthentication frame to the STA 405. The deauthentication frame terminates the current session and denies network access to the STA 405.

If the recovered SNonce′ matches the SNonce in M2, the AP 410 may determine that the STA 405 possess a valid authorization token and proceeds with the handshake. As depicted, the AP generates a second authorization ticket (also referred to as the Authz-ticket2) by encrypting the previously generated ANonce using the Authz-Key-APderived, represented as follows:

$$Authz ‐ Ticket 2 = Encrypt ( ANonce , Authz ‐ Key ‐ APDerived )$$

The AP 410 transmits EAPOL M3 470 to the STA 405, including the ANonce, MIC, RSNIE, GTK (if present), and Authz-ticket2. As depicted by block 475, the STA 405 decrypts the Authz-Ticket2 using the previously derived Authz-Key to recover ANonce′ (also referred to ANonce-STADerived or computed ANonce′), represented as follows:

$$ANonce ‐ STADerived = Decrypt ( Authz ‐ Ticket 2 , Authz ‐ Key )$$

If the recovered ANonce′ matches the ANonce received in M3 470, this confirms that the AP 410 also possesses the correct authorization token. The STA 405 then transmits EAPOL M4 480 to complete the handshake. Following completion of the handshake, the STA 405 and AP 410 may proceed with secure communication or data exchange in accordance with the policy or group configuration associated with the verified authorization ID.

If the recovered ANonce′ does not match the ANonce received in M3, the STA 405 may abort the handshake immediately and treat the AP 410 as untrusted, as the discrepancy may indicate a MiTM attack.

When the AP 410 determines that the recovered SNonce′ does not match with the SNonce included in M2, rather than rejecting the connection outright by sending a deauthentication frame, in some embodiments, the AP 410 may choose to complete the 4-way handshake. In this configuration, the AP 410 may transmit EAPOL M3 470 and accept EAPOL M4 480, but place the STA 405 in a group with limited network access (e.g., guest or default VLAN). This approach supports onboarding new users, where the STA 405 may be granted basic connection to perform registration or credential updates. For example, the STA 405 may submit its authorization ID through a subsequent encrypted message (e.g., EAPOL M4 or a protected action frame). The AP may then reevaluate the STA's identity and potentially elevate the STA's access level based on updated or verified credentials.

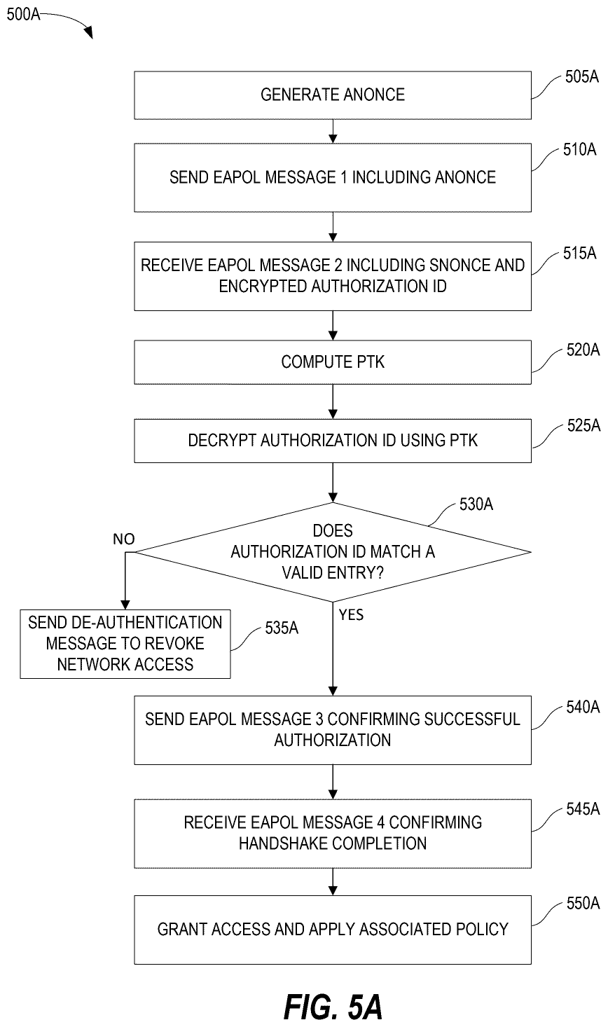

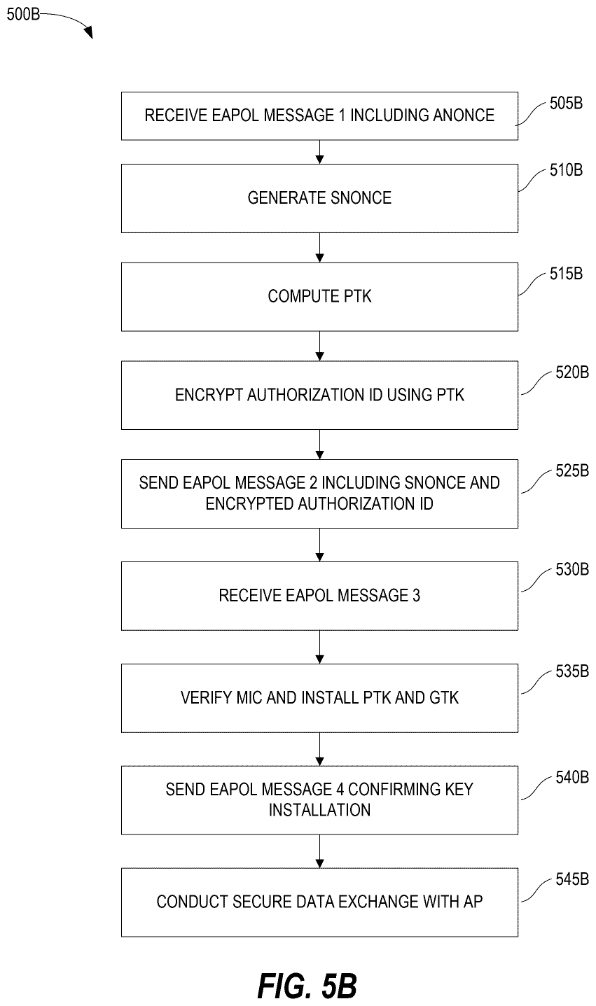

FIG. 5A depicts an example method 500A performed by an AP, where an authorization ID is received from a STA and the AP verifies the STA's identity using the authorization ID during a 4-way handshake process, according to some embodiments of the present disclosure. The AP performing the example method 500A may correspond to AP 110 as depicted in FIG. 1 and/or AP 210 as depicted in FIG. 2. In some embodiments, other network devices, such as WLC or a radius server, may perform part or all of the authorization processing described in FIG. 5A.

The example method 500A illustrated in FIG. 5A is performed after a STA (e.g., 105 of FIG. 1 or 205 of FIG. 2) has completed a successful SAE handshake and association with the AP. At this stage, both the STA and AP have established a PMK using a shared passphrase, and the AP initiates the EAPOL 4-way handshake to derive session keys and verify the STA's authorization.

At block 505A, the AP (e.g., 110 of FIG. 1 or 210 of FIG. 2) generates a random number ANonce for PTK derivation.

At block 510A, the AP generates and transmits EAPOL M1 (e.g., 250 of FIG. 2) to the associated STA (e.g., 105 of FIG. 1 or 205 of FIG. 2). The M1 includes the generated ANonce and protocol flags to initiate the 4-way handshake.

At block 515A, the AP receives EAPOL M2 (e.g., 260 of FIG. 2) from the STA. The M2 includes a STA-generated random value SNonce, a MIC, the RSNIE, and an encrypted authorization ID (also referred to as the Authz-ID). As used here, the authorization ID is a unique value assigned to the STA. APs may use this identifier to verify the STA's identity, assign the STA to a user group, and apply corresponding network policies. In some embodiments, the STA may be provisioned with its Authz-ID either through an OOB mechanism (e.g., scanning a QR code, loading a configuration profile, or using mobile device management (MDM)) or in-band via a separate action frame exchanged after initial authentication (SAE). The action frame may be protected using session keys or public key infrastructure (PKI). Upon receiving the ANonce from the AP in M1, the STA generates its own random value SNonce, and derives the PTK using the previously established PMK (e.g., from SAE handshake), the received ANonce, the locally generated SNonce, and the MAC addresses of both the STA and AP. The PTK derivation may be represented as follows:

$$PTK = PRF ( PMK , ANonce \vert SNonce , AP MAC \vert STA MAC )$$

The PRF represents a pseudo-random function. The temporary key (PTK) generated by the STA is then split into multiple subkeys, including the KEK used for key data encryption. The STA then uses the STA-derived KEK to encrypt its locally stored Authz-ID, and includes it within M2. In one embodiment, the Authz-ID may be encrypted directly using the STA-derived KEK (e.g., represented by Authz-ID-Encrypted). In another embodiment, the Authz-ID may be encoded within an authorization element, such as KDE, and the entire structure may then be encrypted using the KEK (e.g., represented by Authz-ID-KDE).

At block 520A, upon receiving EAPOL M2, which includes the STA-generated SNonce and the STA's MAC address, the AP computes the PTK using the same key derivation process performed by the STA. Specifically, the AP uses the previously established PMK, the received SNonce, its own ANonce, and the MAC addresses of both the AP and the STA as inputs to a pseudo-random function.

At block 525A, after the PTK is derived, the AP uses the KEK (which is a subkey of the AP-generated PTK) to decrypt the received authorization ID included within M2. In embodiments where the STA's claimed Authz-ID is within a KDE, the AP may first parse the encrypted KDE, and then use the KEK to decrypt the encapsulated authorization ID.

At block 530A, the AP checks whether the decrypted Authz-ID matches any valid authorization IDs in its local database or a backend server (e.g., a radius server). If a match is found, this indicates that the STA is a recognized and provisioned device processing a valid authorization ID. The method 500A proceeds to block 540A, where the AP constructs and transmits EAPOL M3 (e.g., 270 of FIG. 2) to the STA. M3 includes the AP's ANonce, a MIC, the RSNIE, and optionally the GTK encrypted with the KEK. At block 545A, the AP receives EAPOL M4 from the STA, which includes a MIC confirming successful handshake completion and key installation on the STA side. At block 550A, the AP grants the STA access to the network and applies the policy associated with the verified Authz-ID. Subsequent secure data exchange is conducted in accordance with access control policies and/or group configurations mapped to the STA's authorization identity.

If no match is found, this indicates that the received authorization data has been compromised or that the STA is not a legitimate entity (which may include scenarios where the STA is a malicious attacker or simply a new device that has not yet been registered or provisioned with a valid authorization ID). In such a configuration, the method 500A proceeds to block 535A, where the AP transmits a deauthentication frame to immediately terminate the handshake and deny the STA access to the network.

In another embodiment, when no match is found, the AP may still complete the handshake by transmitting M3 (e.g., 270 of FIG. 2) and accepting M4 (e.g., 275 of FIG. 1) from the STA. This allows the STA to gain limited or temporary access to the network, for example, being placed in a guest or default VLAN, under the assumption that the STA may be a new or unregistered device. In such configurations, the STA may be allowed to retransmit its authorization ID in a later frame, such as EAPOL M4 or a protected action frame, to complete the onboarding operation.

FIG. 5B depicts an example method 500B performed by a STA for transmitting an authorization ID to an AP for identity verification during a 4-way handshake process, according to some embodiments of the present disclosure. The STA performing the example method 500B may correspond to STA 105 as depicted in FIG. 1 and/or STA 205 as depicted in FIG. 2.

The example method 500B in FIG. 5B is performed after the non-AP STA (e.g., 105 of FIG. 1 or 205 of FIG. 2) has completed a successful SAE exchange and association with an AP (e.g., 110 of FIG. 1 or 210 of FIG. 2). At this stage, both the STA and AP have derived a shared PMK using a common passphrase, and the AP initiates the EAPOL 4-way handshake to derive session keys and verify the STA's authorization.

At block 505B, the STA (e.g., 105 of FIG. 1 or 205 of FIG. 2) receives EAPOL M1 (e.g., 250 of FIG. 2) from the associated AP. The M1 includes the AP-generated random number ANonce.

At block 510B, the STA generates its own random number, SNonce, to be used in the key derivation process.

At block 515B, the STA computes the PTK using the established PMK, the received ANonce, the locally generated SNonce, and the MAC addresses of the AP and the STA. The PTK is then divided into multiple subkeys, including a KEK for encrypting key material, a KCK for computing the MIC, and a TK for data protection.

At block 520B, the STA prepares its authorization ID for secure transmission. In one embodiment, the Authz-ID may be encrypted directly using the KEK. In other embodiments, the Authz-ID may be encapsulated within a KDE or other authorization elements, and then encrypted using the KEK.

At block 525B, the STA transmits EAPOL M2 (e.g., 260 of FIG. 2) to the AP. The M2 includes the locally generated SNonce, a MIC computed using the KCK, the RSNIE, and the encrypted authorization ID (either directly or in a KDE). The AP uses the received data to derive the PTK on its side and performs an authorization check.

At block 530B, the STA receives EAPOL M3 (e.g., 265 of FIG. 2) from the AP. M3 may include the AP's ANonce, a new MIC computed by the AP, the RSNIE, and optionally the GTK (e.g., encrypted with the KEK). If the AP found a match between the decrypted authorization ID and a list of known IDs (e.g., stored locally or accessible via a backend server), the M3 signals that the STA is authorized and the handshake can proceed. In some embodiments, if the authorization check fails (e.g., due to an unrecognized ID), the AP may send a deauthentication frame to the STA, terminating the connection immediately. In some embodiments, even if the authorization check fails, the AP may still send M3 to allow the STA to complete the handshake. However, the AP may place the STA in a restricted-access group (e.g., guest VLAN) for onboarding or temporary connection.

At block 535B, the STA verifies the MIC in M3 (e.g., 265 of FIG. 2) using its generated KEK and installs the PTK and GTK.

At block 540B, the STA sends EAPOL M4 (e.g., 270 of FIG. 2) to the AP, confirming successful key installation and completion of the 4-way handshake. In embodiments supporting delayed authorization (where the authorization check fails but AP still sends M3 but assigns the STA to a restricted-access group), the STA may retransmit its Authz-ID in M4 or in a subsequent protected action frame.

At block 545B, the STA begins secure communication with the AP using the installed keys. If full authorization was granted, the STA is allowed unrestricted access as per its group or policy based on the Authz-ID. If the STA was assigned to a limited-access group for onboarding or temporary connection, the STA may only access restricted resources until authorization is completed or elevated.

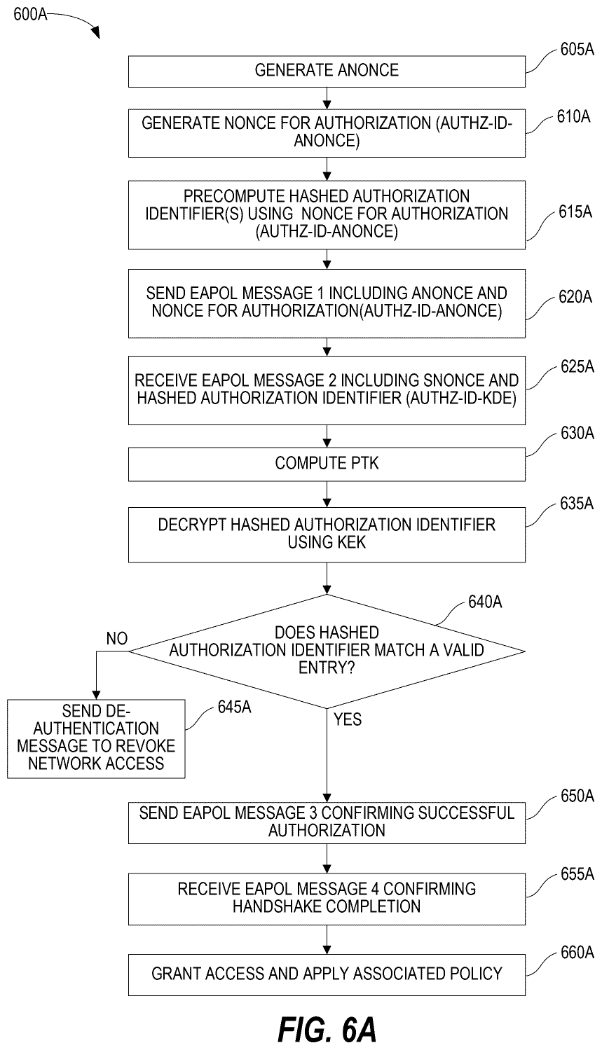

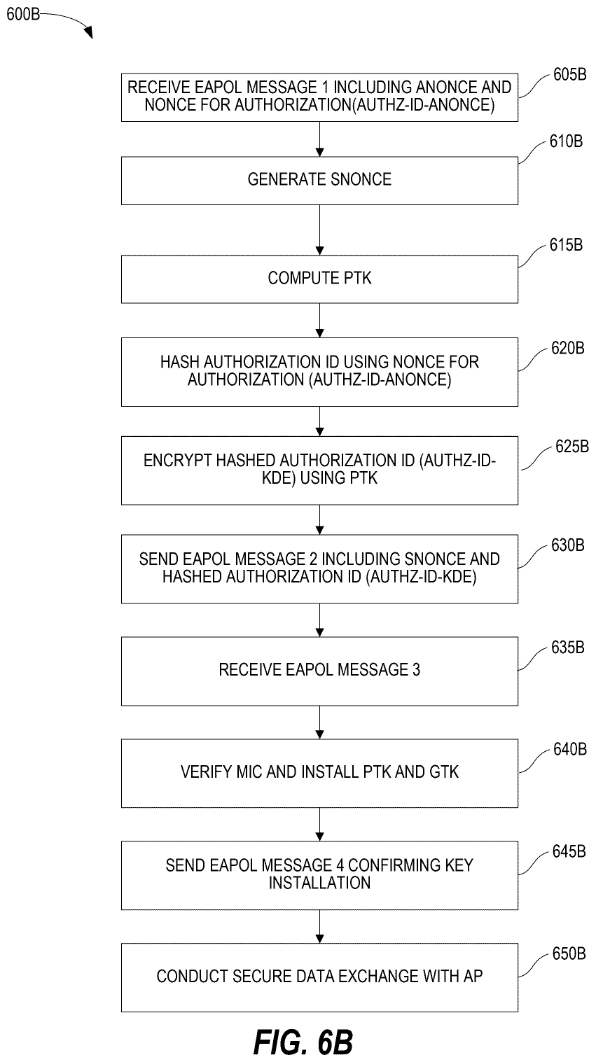

FIG. 6A depicts an example method 600A performed by an AP, where a hashed value for authorization is received from a STA and the AP verifies the STA's identity using the hashed value during a 4-way handshake process, according to some embodiments of the present disclosure. The AP performing the example method 600A may correspond to AP 110 as depicted in FIG. 1 and/or AP 310 as depicted in FIG. 3. In some embodiments, other network devices, such as WLC or a radius server, may perform part or all of the authorization processing described in FIG. 6A.

The example method 600A is performed after the completion of the SAE handshake and the association process, where both the AP (e.g., 310 of FIG. 3) and STA (e.g., 305 of FIG. 3) have derived a shared PTK using a common passphrase.

At block 605A, the AP (e.g., 110 of FIG. 1 or 310 of FIG. 3) generates a random number ANonce to be used during the PTK derivation process.

At block 610A, the AP generates an additional random value specific for authorization (also referred to as Authz-ID-ANonce). The Authz-ID-ANonce is used to randomize the hash computation of the STA's authorization ID.

At block 615A, the AP precomputes a list of expected hashed authorization values using its known list of valid authorization IDs (also referred to as the Authz-ID-Known). For each known authorization ID, the AP applies the same hash function that the STA is expected to use, using the generated Authz-ID-ANonce as input. These values are stored in a temporary hash table for rapid lookup. The precomputation operation may be represented as follows:

$$Expected ‐ Authz ‐ ID ‐ Hashed = Hash ( Authz ‐ ID ‐ Known \vert Authz ‐ ID ‐ ANonce )$$

In some embodiments, the precomputation occurs before the AP transmits EAPOL M1, so that the lookup table is ready by the time the AP receives M2 from the STA. The precomputation enables rapid verification of the authorization ID without delay. In some embodiments, the AP may perform the hash computation on demand, such as after receiving the hashed authorization value from the STA in EAPOL M2.

At block 620A, the AP constructs and transmits EAPOL M1 (e.g., 350 of FIG. 3) to the STA. M1 includes both the ANonce and the Authz-ID-ANonce. Upon receiving M1, the STA generates its own random number SNonce and computes the PTK using the shared PMK (which is determined during SAE), the received ANonce, its SNonce, and the MAC addresses of the AP and STA. The STA also computes a hashed authorization ID (also referred to as the Authz-ID-Hashed) by applying a hash function to its provisioned authorization ID using the received Authz-ID-ANonce as input:

$$Authz ‐ ID ‐ Hashed = Hash ( Authz ‐ ID \vert Authz ‐ ID ‐ ANonce )$$

The hashed value is then encrypted and included in EAPOL M2 (e.g., 360 of FIG. 3), which the STA transmits to the AP.

At block 625A, the AP receives EAPOL M2 (e.g., 360 of FIG. 3) from the STA. M2 includes the STA-generated SNonce, a MIC, the RSNIE, and an encrypted authorization element (e.g., a KDE) that encapsulates the hashed authorization ID (also referred to as the Authz-ID-KDE).

At block 630A, the AP computes the PTK using the shared PMK, the received SNonce, its previously generated ANonce, and the MAC addresses of both the AP and the STA. The PTK derivation process may be represented as follows:

$$PTK = PRF ( PMK , ANonce \vert SNonce , AP MAC \vert STA MAC )$$

The PTK is divided into several subkeys, including KEK, which is used for decrypting key data received from the STA.

At block 635A, the AP decrypts the received KDE (also referred to as the Authz-ID-KDE) to extract the Authz-ID-Hashed value. The value was computed by the STA using its provisioned authorization ID and the Authz-ID-ANonce received in M1.

At block 640A, the AP compares the extracted Authz-ID-Hashed against a precomputed set of expected hashed values generated at block 615A. Each expected value (also referred to as the Expected-Authz-ID-Hashed) was computed using a known valid authorization ID and the same Authz-ID-ANonce. A match indicates that the STA possesses a valid authorization ID corresponding to one of the authorized entries. If a match is found, the AP confirms that the STA possesses a valid authorization ID and is recognized by the network. The method proceeds to block 650A, where the AP constructs and transmits EAPOL M3 (e.g., 370 of FIG. 3) to the STA. M3 includes the AP's ANonce, a MIC computed with the KCK, and the RSNIE, and a GTK (optional).

At block 655A, the AP receives EAPOL M4 (e.g., 375 of FIG. 3) from the STA, which includes a MIC indicating that the STA has verified M3 and installed the PTK and GTK (if present).

At block 660A, the AP grants the STA access to the network and applies the policy or configuration associated with the matched authorization ID. Secure data exchange may proceed in accordance with the group access level assigned to the STA.

If no match is found at block 640A—the extracted Authz-ID-Hashed does not match any precomputed expected values—this indicates that the STA's authorization ID is either invalid, unregistered, or potentially compromised. The method proceeds to block 645A.

At block 645A, in response to a failed authorization check, the AP transmits a deauthentication frame to the STA, immediately terminating the handshake and denying access to the network. In another embodiment, rather than rejecting the STA outright, the AP may still transmit EAPOL M3 (e.g., 370 of FIG. 3) and accept EAPOL M4 M3 (e.g., 375 of FIG. 3), allowing the handshake to complete. In this configuration, the STA is placed in a restricted group (e.g., guest or default VLAN), with limited access. This allows the network to support onboarding for new or unprovisioned devices.

FIG. 6B depicts an example method 600B performed by a STA for transmitting a hashed value for authorization to an AP for identity verification during a 4-way handshake process, according to some embodiments of the present disclosure. The STA performing the example method 600B may correspond to STA 105 as depicted in FIG. 1 and/or STA 305 as depicted in FIG. 3.

The example method 600B is initiated after the STA (e.g., 305 of FIG. 3) has successfully completed the SAE handshake and association with the AP (e.g., 310 of FIG. 3). At this stage, the STA and AP have derived a shared PMK (using a common passphrase), and the 4-way handshake begins to establish session keys and verify the STA's authorization.

At block 605B, a STA (e.g., 105 of FIG. 1 or 305 of FIG. 3) receives EAPOL M1 (e.g., 350 of FIG. 3) from the AP. The message includes the AP-generated ANonce and an authorization-specific random value (also referred to as the Authz-ID-ANonce). In some embodiments, the Authz-ID-ANonce may be used by the STA to derive a session-unique hashed version of its authorization ID.

At block 610B, the STA generates its own random number SNonce for PTK derivation.

At block 615B, the STA computes the PTK using the shared PMK, the received ANonce, the generated SNonce, and the MAC addresses of the AP and STA. The PTK includes multiple subkeys, including KEK for encrypting key data and KCK for computing the MIC.

At block 620B, the STA computes a session-specific hashed authorization value by hashing its provisioned authorization ID with the received Authz-ID-ANonce:

$$Authz ‐ ID ‐ Hashed = Hash ( Authz ‐ ID \vert Authz ‐ ID ‐ ANonce )$$

At block 625B, the STA encapsulates the hashed authorization value within a KDE and encrypts the element using the KEK, referred to as the Authz-ID-KDE.

At block 630B, the STA transmits EAPOL M2 (e.g., 360 of FIG. 3) to the AP. The M3 includes the generated SNonce, a MIC computed using the KCK, the RSNIE, and the encrypted Authz-ID-KDE. Upon receiving M2, the AP derives the PTK using the same input, decrypts the Authz-ID-KDE, and compares the extracted hashed value (e.g., the Authz-ID-Hashed) with a precomputed list of expected values. If a match is found, this indicates that the STA has a valid authorization ID, and the AP proceeds to send EAPOL M3 (e.g., 370 of FIG. 3). If no match is found, the AP may terminate the handshake with a deauthentication frame or proceed with limited access handling.

At block 635B, the STA receives EAPOL M3 (e.g., 370 of FIG. 3) from the AP. The M3 includes the AP's ANonce, a MIC, the RSNIE, and optionally the GTK. At block 640B, the STA verifies the MIC using its own KCK and, if valid, installs the PTK and GTK (if present). At block 645B, the STA transmits EAPOL M4 (e.g., 375 of FIG. 3) to the AP, confirming the successful installation of session keys and completion of the 4-way handshake. At block 650B, the STA begins secure communication with the AP using the installed keys. If the AP verifies the authorization ID successfully, the STA is granted full access based on its assigned group or policy. In some embodiments, even if no match was found (e.g., the Authz-ID is unregistered), the AP may still send M3 and accept M4, placing the STA in a restricted-access group (e.g., guest VLAN). In this configuration, the STA may continue with limited network access until it completes onboarding or reauthorization.

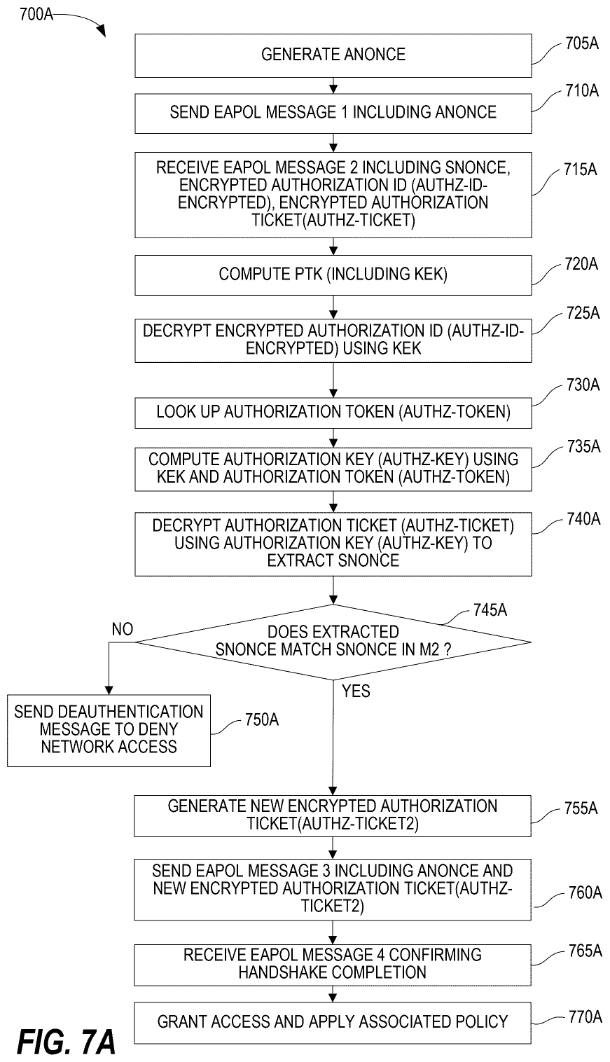

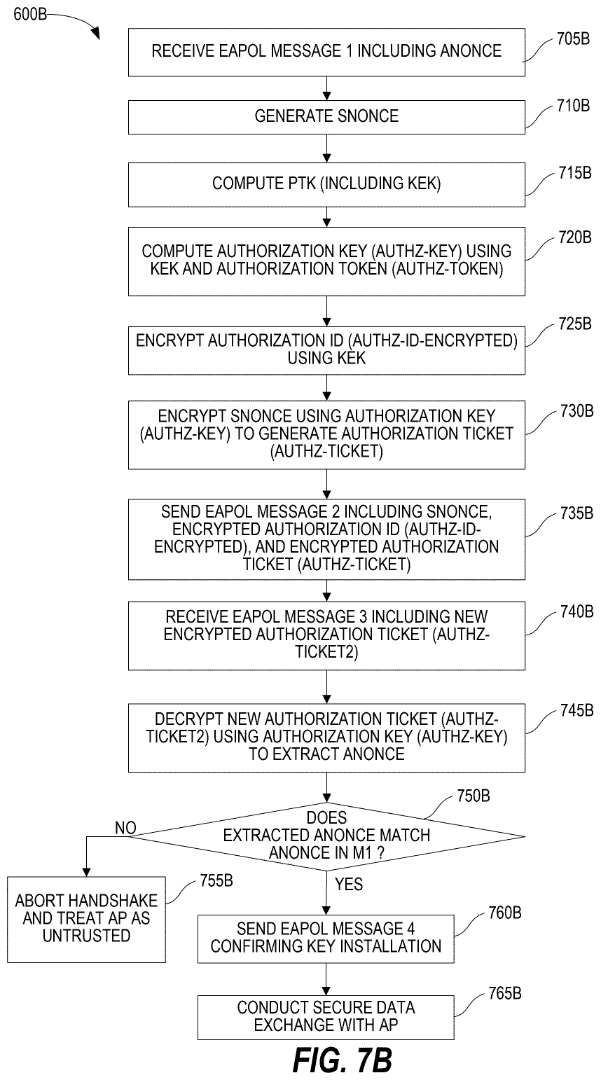

FIG. 7A depicts an example method 700A performed by an AP, where an encrypted authorization ID and an associated authorization token are used to verify an STA's identity during a 4-way handshake process, according to some embodiments of the present disclosure. The AP performing the example method 700A may correspond to AP 110 as depicted in FIG. 1 and/or AP 410 as depicted in FIG. 4. In some embodiments, other network devices, such as WLC or a radius server, may perform part or all of the authorization processing described in FIG. 7A.

The example method 700A is performed after the completion of the SAE using a shared passphrase and a successful association between the STA (e.g., 405 of FIG. 4) and the AP (e.g., 410 of FIG. 4). At this stage, both devices have derived a shared PMK, and the 4-way handshake is initiated to establish PTK and perform mutual authorization.

In this embodiment, each STA is provisioned with both an authorization ID (also referred to as Authz-ID) and a corresponding authorization token (also referred to as Authz-Token). The token is used to bind authorization to the current session and therefore prevent permanent theft or reuse of the authorization ID by an attacker. The Authz-ID and Authz-Token may be provisioned via an OOB (e.g., QR scan) or in-band via a protected action frame from initial authentication.

At block 705A, the AP (e.g., 110 of FIG. 1 or 410 of FIG. 4) generates a random number ANonce for use in PTK derivation.

At block 710A, the AP transmits EAPOL M1 (e.g., 450 of FIG. 4) to the STA, including the generated ANonce. Upon receiving M1, the STA generates a local SNonce and computes the PTK using the previously established PMK (from SAE), the received ANonce, the locally generated SNonce, and both devices' MAC addresses. The resulting PTK includes a KEK for encrypting key material. The STA then derives a session-specific authorization key (also referred to as the Authz-Key) by hashing the KEK together with its provisioned authorization token (also referred to as the Authz-Token). With the Authz-Key, the STA further generates an authorization ticket (also referred to as the Authz-Ticket) by encrypting the locally generated SNonce. Moreover, the STA encrypts its locally stored authorization ID using the KEK. The encrypted authorization ID may also be referred to as the Authz-ID-Encrypted. These values, including SNonce, Authz-ID-Encrypted, and Authz-Ticket, are then prepared for inclusion in EAPOL M2.

At block 715A, the AP receives EAPOL M2 (e.g., 460 of FIG. 4) from the STA, which includes the STA-generated SNonce, the encrypted authorization ID (Authz-ID-Encrypted), the authorization ticket (Authz-Ticket), a MIC computed by the AP, and the RSNIE.

At block 720A, the AP computes the PTK using the same inputs as the STA, including the previously established PMK (from SAE), the received ANonce, the locally generated SNonce, and the MAC addresses of the AP and the STA. The PTK is then split into multiple subkeys including the KEK.

At block 725A, the AP uses the KEK (a subkey of the AP-generated PTK) to decrypt the Authz-ID-Encrypted and recover the STA's authorization ID.

At block 730A, the AP uses the recovered Authz-ID to retrieve the corresponding Authz-Token (also referred to as Authz_Token_APStored), either from a local database or by querying a radius server (e.g., 120 of FIG. 2) or central controller (e.g., 115 of FIG. 1).

At block 735A, the AP derives its own version of the authorization key (also referred to as the Authz-Key-APDerived) using the AP-generated KEK and the retrieved authorization token (Authz-Token).

At block 740A, the AP decrypts the Authz-Ticket using the derived Authz-Key and extracts the value of SNonce′ (also referred to as SNonce-APDerived or computed SNonce′).

At block 745A, the AP compares the extracted SNonce′ with the SNonce received in M2. If the values match, this indicates that the STA possesses a valid authorization token, and the two sides (the AP and the STA) share the same session context. The method 700A proceeds to block 755A.

If the values do not match, this may indicate a MiTM attack and/or the STA does not possess a valid authorization token. The method 700A moves to block 750A, where the AP transmits a deauthentication frame to terminate the handshake and deny network access to the STA. In some embodiments, instead of rejecting the STA outright, the AP may still complete the handshake (e.g., by sending M3 and accepting M4) but place the STA into a restricted-access group (e.g., guest VLAN) for temporary and/or onboarding access.

If a match was found in the comparison of the computed SNonce′ with the SNonce received in M2, the AP determines that the STA possesses a valid authorization token. The method 700A moves to block 755A, where the AP constructs a second authorization ticket (also referred to as the Authz-Ticket2) by encrypting the locally generated ANonce using the derived Authz-Key-APDerived. At block 760A, the AP transmits the ticket to the STA in EAPOL M3 (e.g., 470 of FIG. 4), along with the MIC computed by the AP, the RSNIE, and optionally a GTK. Upon receiving M3, the STA performs a second step of mutual verification. The STA first decrypts the received Authz-Ticket2 using the STA-generated Authz-Key to extract an ANonce′ (also referred to as the ANonce-STADerived or computed ANonce′). The STA then compares the computed ANonce's to the ANonce previously received from the AP in M1. If the values match, this confirms that the AP also possesses the valid authorization token. The STA then transmits EAPOL M4 to the AP. As depicted, at block 765A, the AP receives EAPOL M4 (e.g., 480 of FIG. 4), confirming successful mutual verification and key installation. At block 770A, the AP grants the STA access to the network and applies the policy or group configuration associated with the verified authorization ID.

If the computed ANonce′ does not match the ANonce received in M1, this may indicate that the AP does not possess the correct authorization token or that a MiTM attack is occurring. In such configurations, the STA may abort the handshake and treat the AP as an untrusted entity. Optionally, the STA may transmit a rejection message to the STA.

FIG. 7B depicts an example method 700B performed by a STA for transmitting an encrypted authorization ID and a session-based authorization ticker derived from an authorization token to an AP for identity verification during a 4-way handshake process, according to some embodiments of the present disclosure. The STA performing the example method 700B may correspond to STA 105 as depicted in FIG. 1 and/or STA 405 as depicted in FIG. 4.

The example method 700B is performed after the STA (e.g., 405 of FIG. 4) has successfully completed the SAE handshake and association with the AP (e.g., 410 of FIG. 4).

At block 705B, the STA (e.g., 405 of FIG. 4) receives EAPOL M1 (e.g., 450 of FIG. 4) from the AP, which includes the AP-generated ANonce.

At block 710B, the STA generates a random value SNonce for PTK derivation.

At block 715B, the STA computes the PTK using the previously established PMK (which is determined during SAE), the received ANonce, the locally generated SNonce, and the MAC addresses of the AP and STA. The PTK is then divided into several subkeys, including KEK.

At block 720B, the STA derives an authorization key (Authz-Key) by hashing the KEK together with its provisioned authorization token (Authz-Token).

At block 725B, the STA encrypts its provisioned authorization ID (Authz-ID) using the KEK to produce an encrypted authorization ID (Authz-ID-Encrypted). At block 730B, the STA encrypts the SNonce using the Authz-Key to generate an Authz-Ticket.

At block 735B, the STA constructs and transmits EAPOL M2 (e.g., 460 of FIG. 4) to the AP. The M2 included the SNonce, the Authz-ID-Encrypted, the Authz-Ticket, a MIC computed by the AP using KCK, and the RSNIE. Upon receiving M2, the AP derives the PTK, decrypts the Authz-ID-Encrypted and retrieves the corresponding Authz-Token. With the retrieved Authz-Token and its locally generated KEK, the AP derives its own Authz-Key-APDerived and decrypts the Authz-Ticket to recover SNonce′. The AP then compares the recovered SNonce′ with the SNonce sent in M2. If they match, the AP proceeds to send M3 (e.g., 470 of FIG. 4). If they do not match, the AP may send a deauthentication frame or allow limited access.

At block 740B, the STA receives EAPOL M3 from the AP, which includes a second authorization ticket (Authz-Ticket2), which is an encrypted version of ANonce generated using the AP's copy of Authz-Key.

At block 745B, the STA decrypts the received Authz-Ticket2 using its own locally generated Authz-Key to extract ANonce′.

At block 750B, the STA compares the extracted ANonce′ with the original ANonce it received in M1. If the values match, this confirms that the AP possesses the correct authorization token. The method proceeds to block 760B, where the STA transmits EAPOL M4 (e.g., 475 of FIG. 4) to the AP, confirming successful mutual authorization and key installation. The method 700B then moves to block 765B, where the AP and the STA conduct secure data exchange using the established PTK. The STA is granted access based on the network policy or group configuration associated with its verified Authz-ID. In embodiments where the AP's verification fails (e.g., the computed SNonce′ does not match the SNonce received in M2), the AP may still allow the handshake to complete and place the STA into a restricted group with limited network access. In this configuration, the STA may still perform basic communication tasks and transmit its Authz-ID again in M4 or a protected action frame to initiate registration. This approach allows new or unprovisioned devices to be onboarded without interrupting the overall handshake flow.

If, at block 750B, the extracted ANonce′ does not match the original ANonce, this indicates that the AP does not possess the correct token or that a MiTM attack is occurring. In such configurations, the method 700B proceeds to block 755B, where the STA aborts the handshake and treats the AP as untrusted. Optionally, the STA may transmit a rejection message to the AP, informing the AP of the abortion.

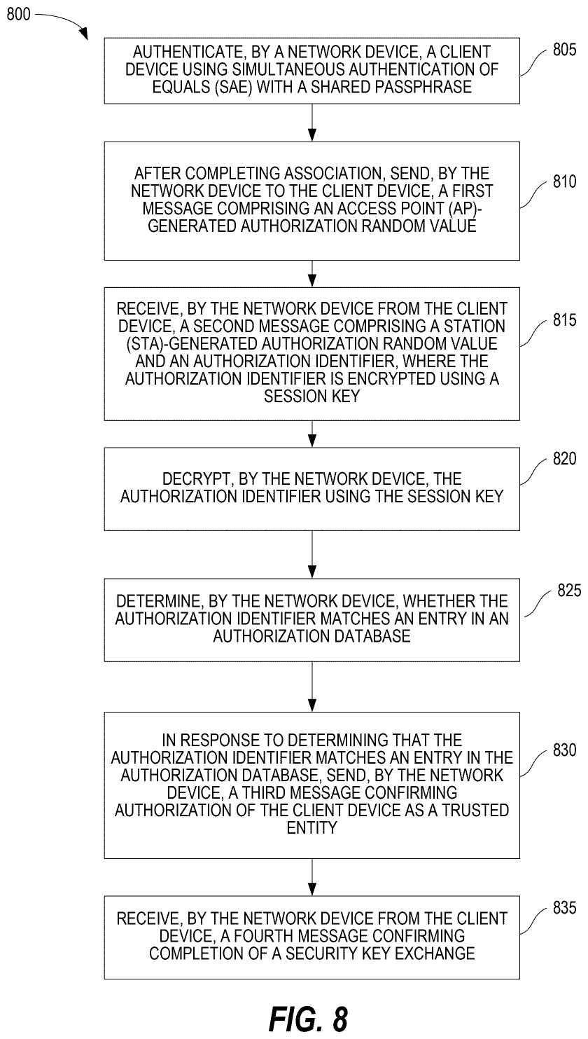

FIG. 8 is a flow diagram depicting an example method 800 for authorization verification using an authorization ID encrypted with a session key, according to some embodiments of the present disclosure.

At block 805, a network device (e.g., 110 of FIG. 1 or 210 of FIG. 2) authenticates a client device (e.g., 105 of FIG. 1 or 205 of FIG. 2) using simultaneous authentication of equals (SAE) with a shared passphrase.

At block 810, after completing association, the network device sends a first message to the client device, the first message (e.g., 250 of FIG. 2) comprising an access point (AP)-generated authorization random value (e.g., ANonce).

At block 815, the network device receives a second message from the client device, the second message comprising a station (STA)-generated authorization random value (e.g., SNonce) and an authorization identifier (e.g., Authz-ID), where the authorization identifier is encrypted using a session key (e.g., KEK).

At block 820, the network device decrypts the authorization identifier using the session key.

At block 825, the network device determines whether the authorization identifier matches an entry in an authorization database.

At block 830, in response to determining that the authorization identifier matches an entry in the authorization database, the network device sends a third message (e.g., 270 of FIG. 2) confirming authorization of the client device as a trusted entity.

At block 835, the network device receives a fourth message (e.g., 275 of FIG. 2) from the client device, confirming completion of a security key exchange.

In some embodiments, the session key may comprise a key encrypting key (KEK), and the session key may be computed using the shared passphrase, the AP-generated authorization random value, the STA-generated authorization random value, an address of the network device, and an address of the client device.

In some embodiments, the authorization identifier may be encrypted directly using the KEK before being transmitted in the second message by the client device to the network device.

In some embodiments, the authorization identifier may be included within a key data element (KDE), where the KDE is encrypted using the KEK before being transmitted in the second message by the client device to the network device.

In some embodiments, the network device may comprise at least one of an AP (e.g., 110 of FIG. 1), a radius server (e.g., 120 of FIG. 1), or a wireless controller (e.g., 115 of FIG. 1).

In some embodiments, in response to determining that the authorization identifier does not match an entry in the authorization database, the network device may send a deauthentication message indicating that the client device is not a trusted entity and denying access of the client device to a network managed by the network device.

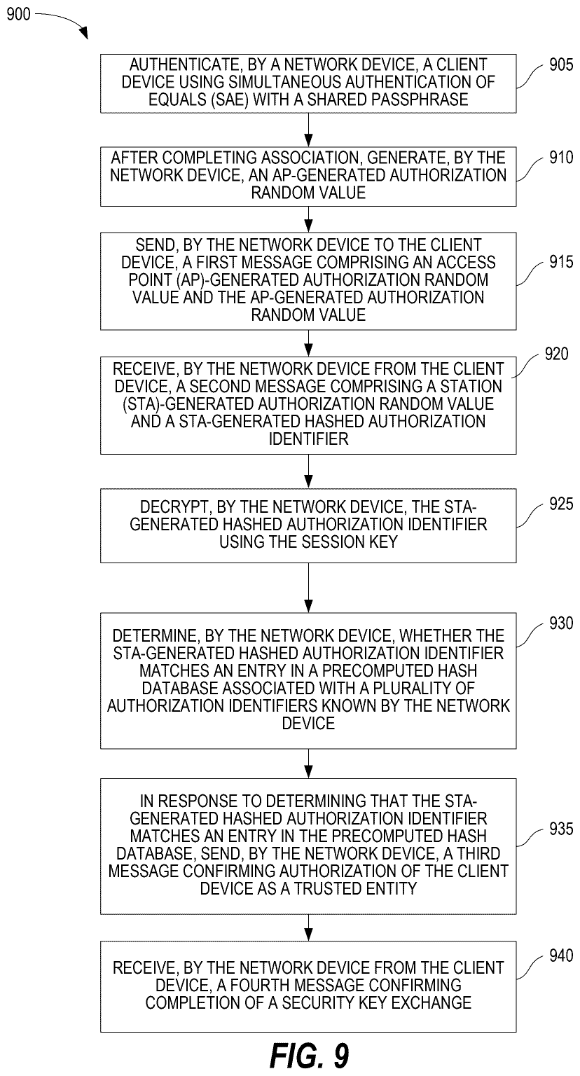

FIG. 9 is a flow diagram depicting an example method 900 for authorization verification using a hashed authorization ID generated with an AP-provided random value, according to some embodiments of the present disclosure.

At block 905, a network device (e.g., 110 of FIG. 1 or 310 of FIG. 3) authenticates a client device (e.g., 105 of FIG. 1 or 305 of FIG. 3) using simultaneous authentication of equals (SAE) with a shared passphrase.

At block 910, after completing association, the network device generates an AP-generated authorization random value (e.g., Authz-ID-ANonce).

At block 915, the network device sends a first message to the client device, the first message (e.g., 350 of FIG. 3) comprising an access point (AP)-generated authorization random value (e.g., ANonce) and the AP-generated authorization random value (e.g., Authz-ID-ANonce).

At block 920, the network device receives, from the client device, a second message (e.g., 360 of FIG. 3) comprising a station (STA)-generated authorization random value (e.g., SNonce) and a STA-generated hashed authorization identifier (e.g., Authz-ID-Hashed). In some embodiments, the STA-generated hashed authorization identifier may be computed by the client device by applying a hash function to an authorization identifier (e.g., Authz-ID) associated with the client device using the AP-generated authorization random value (e.g., Authz-ID-ANonce), and the STA-generated hashed authorization identifier is encrypted using a session key (e.g., KEK).

At block 925, the network device decrypts the STA-generated hashed authorization identifier using a session key (e.g., KEK).

At block 930, the network device determines whether the STA-generated hashed authorization identifier (e.g., Authz-ID-Hashed) matches an entry in a precomputed hash database associated with a plurality of authorization identifiers known by the network device.

At block 935, in response to determining that the STA-generated hashed authorization identifier matches an entry in the precomputed hash database, the network device sends a third message (e.g., 370 of FIG. 3) confirming authorization of the client device as a trusted entity.

At block 940, the network device receives a fourth message (e.g., 375 of FIG. 3) from the client device, the fourth message confirming completion of a security key exchange.

In some embodiments, the session key may comprise a key encryption key (KEK), and the session key may be computed using the shared passphrase, the AP-generated authorization random value, the STA-generated authorization random value, an address of the network device, and an address of the client device.

In some embodiments, the STA-generated hashed authorization identifier may be included within a key data element (KDE), where the KDE is encrypted using the KEK before being transmitted in the second message by the client device to the network device.

In some embodiments, the network device may comprise at least one of an AP (e.g., 110 of FIG. 1), a radius server (e.g., 120 of FIG. 1), or a wireless controller (e.g., 115 of FIG. 1).

In some embodiments, in response to determining that the STA-generated hashed authorization identifier does not match an entry in the precomputed hash database, the network device may send a deauthentication message to the client device, the deauthentication message indicating that the client device is not a trusted entity and denying access of the client device to a network managed by the network device.

In some embodiments, the network device may further precompute a plurality of STA-generated hashed authorization identifiers by applying a hash function to the plurality of authorization identifiers known by the network device using the AP-generated authorization random value, and store the plurality of precomputed STA-generated hashed authorization identifiers in the precomputed hash database for verification.

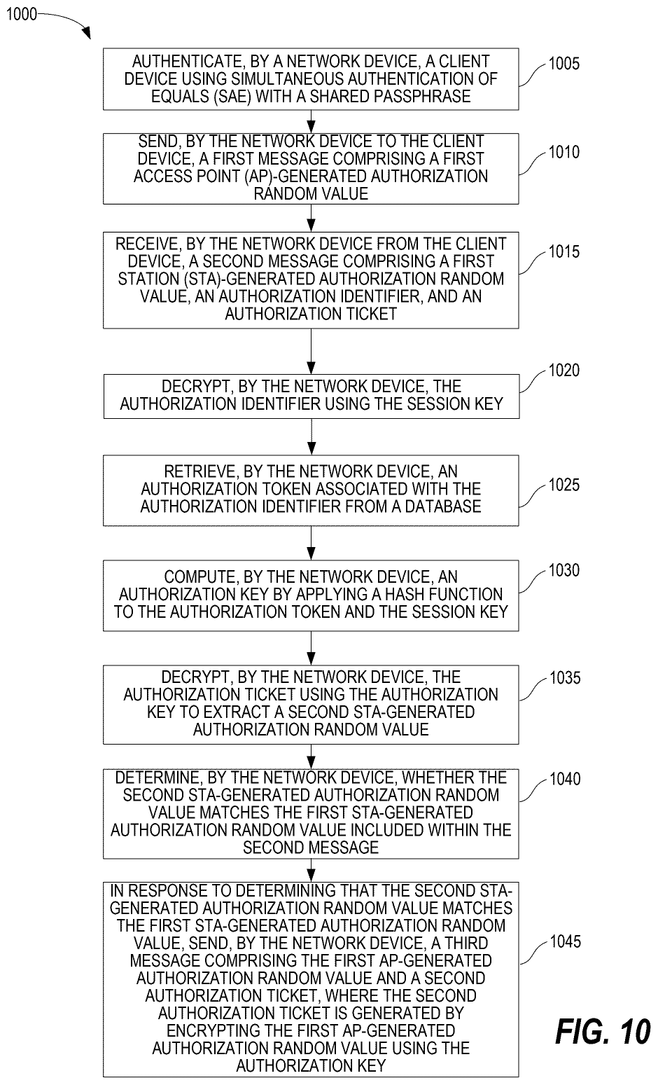

FIG. 10 is a flow diagram depicting an example method 1000 for authorization verification using an encrypted authorization ID and an associated authorization token, according to some embodiments of the present disclosure.

At block 1005, a network device (e.g., 110 of FIG. 1 or 410 of FIG. 3) authenticates a client device (e.g., 105 of FIG. 1 or 405 of FIG. 3) using simultaneous authentication of equals (SAE) with a shared passphrase.

At block 1010, the network device sends a first message (e.g., 450 of FIG. 4) to the client device, the first message comprising a first access point (AP)-generated authorization random value (e.g., ANonce).

At block 1015, the network device receives a second message (e.g., 460 of FIG. 4) comprising a first station (STA)-generated authorization random value (e.g., SNonce), an authorization identifier (e.g., Authz-ID-Encrypted), and an authorization ticket (e.g., Authz-Ticket). In some embodiments, the authorization identifier may be encrypted using a session key (e.g., KEK), and the authorization ticket is generated by encrypting the first STA-generated authorization random value (e.g., SNonce) using a STA authorization key (e.g., Authz-Key or Authz-Key-STADerived).

At block 1020, the network device decrypts the authorization identifier (e.g., Authz-ID) using a session key (e.g., KEK).

At block 1025, the network device retrieves an authorization token (e.g., Authz_Token_APStored) associated with the authorization identifier from a database.

At block 1030, the network device computes an AP-authorization key (e.g., Authz-Key-APDerived) by applying a hash function to the authorization token (e.g., Authz_Token_APStored) and the session key (e.g., KEK).

At block 1035, the network device decrypts the authorization ticket (e.g., Authz-Ticket) using the AP-authorization key (e.g., Authz-Key-APDerived) to extract a second STA-generated authorization random value (e.g., SNonce′).

At block 1040, the network device determines whether the second STA-generated authorization random value (e.g., SNonce′) matches the first STA-generated authorization random value (e.g., SNonce) included within the second message.

At block 1045, in response to determining that the second STA-generated random value (e.g., SNonce′) matches the first STA-generated authorization random value (e.g., SNonce), the network device sends a third message (e.g., 470 of FIG. 4) to the client device, the third message comprising the first AP-generated authorization random value (e.g., ANonce) and a second authorization ticket (e.g., Authz-Ticket2), where the second authorization ticket is generated by encrypting the first AP-generated authorization random value (e.g., SNonce) using the AP-authorization key (e.g., Authz-Key-APDerived).

In some embodiments, in response to determining that the second STA-generated authorization random value (e.g., SNonce′) does not match the first STA-generated authorization random value (e.g., SNonce), the network device may send a deauthentication message indicating that the client device is not a trusted entity and denying access of the client device to a network managed by the network device.

In some embodiments, the client device, upon receiving the first message (e.g., 450 of FIG. 4), may compute the STA-authorization key (e.g., Authz-Key or Authz-Key-STADerived) by applying the hash function to the authorization token (e.g., Authz-Token) and the session key (e.g., KEK), where the authorization token is associated with the authorization identifier (e.g., Authz-ID), and the authorization token and the authorization identifier are assigned to the client device.

In some embodiments, the client device, upon receiving the third message (e.g., 470 of FIG. 4), may decrypt the second authorization ticket (e.g., Authz-Ticket2) using the STA-authorization key (e.g., Authz-Key or Authz-Key-STADerived), extract a second AP-generated authorization random value (e.g., ANonce′) from the authorization ticket, and determine whether the second AP-generated authorization random value (e.g., ANonce′) matches the first AP-generated authorization random value (e.g., ANonce) included within the second message.

In some embodiments, in response to determining that the second AP-generated authorization random value (e.g., ANonce′) matches the first AP-generated authorization random value (e.g., ANonce) included within the second message, the client device may send a fourth message (e.g., 480 of FIG. 4) to the network device indicating a successful verification of the authorization identifier.

In some embodiments, in response to determining that the second AP-generated authorization random value (e.g., ANonce′) does not match the first AP-generated authorization random value (e.g., ANonce), the client device may terminate a current connection with the AP.

In some embodiments, the client device may send a rejection message to the network device indicating a failure of verification of the authorization identifier.

In some embodiments, the network device may comprise at least one of an AP (e.g., 110 of FIG. 1), a radius server (e.g., 120 of FIG. 1), or a wireless controller (e.g., 115 of FIG. 1).

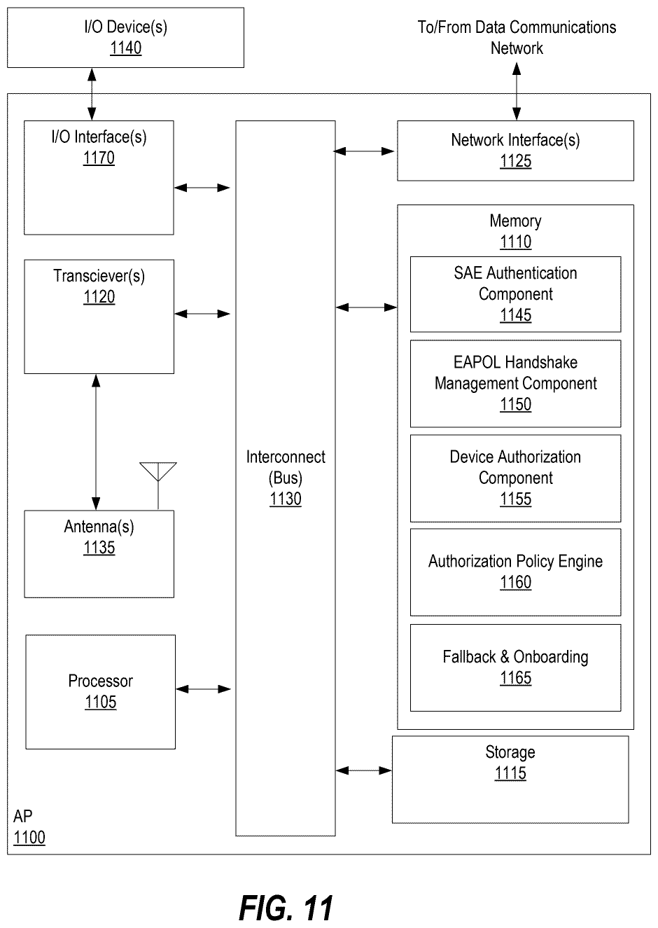

FIG. 11 depicts an example network device 1100 configured to perform various aspects of the present disclosure, according to some aspects of the present disclosure. In some embodiments, the example network device 1100 may be an AP or any other type of network device (e.g., a router, switch, or network controller) that is capable of supporting the described functionality. In some embodiments, the example network device 1100 may correspond to APs 110, 210, 310, and 410 as depicted in FIGS. 1-4.

As illustrated, the example network device 1100 includes a processor 1105, memory 1110, storage 1115, one or more transceivers 1120, one or more I/O interfaces 1180, and one or more network interfaces 1125. In some embodiments, I/O devices 1140 are connected via the I/O interface(s) 1180. Further, via the network interface 1125, the network device 1100 can be communicatively coupled with one or more other devices and components (e.g., via a network, which may include the Internet, local network(s), and the like). Each of the components is communicatively coupled by one or more buses 1130. In some embodiments, one or more antennas 1135 may be coupled to the transceivers 1120 for transmitting and receiving wireless signals.

The processor 1105 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1105 processes information received through the transceiver 1120, I/O interfaces 1180, and the network interfaces 1125. The processor 1105 retrieves and executes programming instructions stored in memory 1110, as well as stores and retrieves application data residing in storage 1115.

The storage 1115 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1115 may store a variety of data for the efficient functioning of the system.

The memory 1110 may include random access memory (RAM) and read-only memory (ROM). The memory 1110 may store processor-executable software code containing instructions that, when executed by the processor 1105, enable the network device 1100 to perform various functions described herein for wireless communication. In the illustrated example, the memory 1110 includes five software components: the SAE authentication component 1145, the EAPOL handshake management component 1150, the device authorization component 1155, the authorization policy engine 1160, and the fallback and onboarding component 1165.

In one embodiment, the SAE authentication component 1145 is configured to perform SAE using a shared passphrase to establish a PMK with a STA (e.g., 105 of FIG. 1). More specifically, the SAE authentication component 1145 handles message exchanges and cryptographic operations for completing the SAE handshake.

In one embodiment, the EAPOL handshake management component 1150 is configured to initiate and process messages exchanged during the 4-way handshake, including generation and handling of nonces (e.g., ANonce, SNonce), computation of the PTK, and decryption of received authorization ID or relevant parameters.

In one embodiment, the device authorization component 1155 is configured to manage authorization information (e.g., Authz-ID) associated with a non-AP STA during the 4-way handshake. In one embodiment, the device authorization component 1155 may decrypt a per-device authorization ID using the KEK (derived from the PTK). In one embodiment, the authorization ID may be encapsulated within a KDE structure for transmission to the AP. In one embodiment, the device authorization component 1155 may compute a hash of each stored authorization ID using a per-session authorization nonce (e.g., Authz-ID-ANonce). The resulting hashed value is then used for comparison against a value received from the STA to verify authorization. In one embodiment, the device authorization component 1155 may first decrypt the authorization ID using a session-specific key (e.g., KEK) and retrieve the stored corresponding authorization token. With the retrieved authorization token, the component 1155 may then derive an authorization key by hashing the KEK and the stored authorization token. With the authorization key, the component 1155 may decrypt a received authorization ticket to recover a nonce (e.g., SNonce) for non-AP STA identity verification.

In one embodiment, the authorization policy engine 1160 is configured to determine whether a received or computed authorization ID is valid based on comparison with a stored list or by communicating with a backend authentication service. Based on the result, the authorization policy engine 1160 applies a corresponding policy or group access control configuration.

In one embodiment, the fallback and onboarding component 1165 is configured to support limited access onboarding. In embodiments where an authorization check fails, the component 1165 places the STA into a restricted group or VLAN. The STA is allowed to continue connection but with limited network access until completing reauthorization or registration.

Although depicted as a discrete component for conceptual clarity, in some embodiments, the operations of the depicted components (and others not illustrated) may be combined or distributed across any number of components. Further, although depicted as software residing in memory 1110, in some aspects, the operations of the depicted components (and others not illustrated) may be implemented using hardware, software, or a combination of hardware and software.

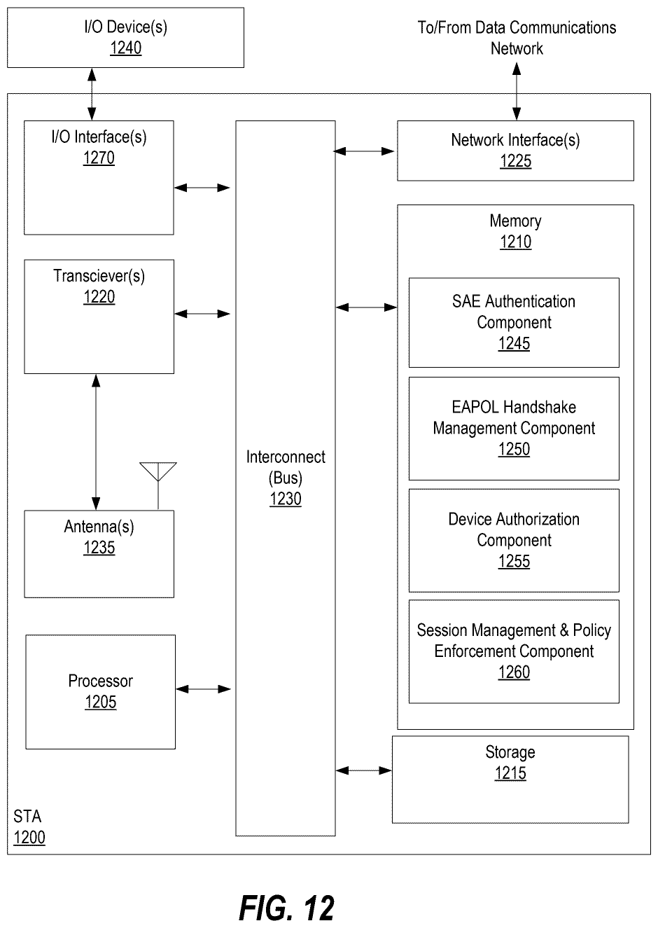

FIG. 12 depicts an example client device 1200 configured to perform various aspects of the present disclosure, according to some aspects of the present disclosure.

In some embodiments, the example client device 1200 may correspond to STA 105, 205, 305, and 405 as shown in FIGS. 1-4. Examples of client devices include smartphones, laptops, IoT devices, or any other wireless computing devices.

As illustrated, the example network device 1200 includes a processor 1205, memory 1210, storage 1215, one or more transceivers 1220, one or more I/O interfaces 1280, and one or more network interfaces 1225. In some embodiments, I/O devices 1240 are connected via the I/O interface(s) 1280. Further, via the network interface 1225, the network device 1200 can be communicatively coupled with one or more other devices and components (e.g., via a network, which may include the Internet, local network(s), and the like). Each of the components is communicatively coupled by one or more buses 1230. In some embodiments, one or more antennas 1235 may be coupled to the transceivers 1220 for transmitting and receiving wireless signals.

The processor 1205 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1205 processes information received through the transceiver 1220, I/O interfaces 1280, and the network interfaces 1225. The processor 1205 retrieves and executes programming instructions stored in memory 1210, as well as stores and retrieves application data residing in storage 1215.

The storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1215 may store a variety of data for the efficient functioning of the system.

The memory 1210 may include random access memory (RAM) and read-only memory (ROM). The memory 1210 may store processor-executable software code containing instructions that, when executed by the processor 1205, enable the network device 1200 to perform various functions described herein for wireless communication. In the illustrated example, the memory 1210 includes four software components: the SAE authentication component 1245, the EAPOL handshake management component 1250, the device authorization component 1255, the session management and policy enforcement component 1260.

In one embodiment, the SAE authentication component 1245 is configured to perform SAE using a shared passphrase to establish a PMK with a nearby AP (e.g., 110, 210, 310, or 410 as depicted in FIGS. 1-4). More specifically, the SAE authentication component 1245 handles message exchanges and cryptographic operations for completing the SAE handshake.

In one embodiment, the EAPOL handshake management component 1250 is configured to process messages exchanged during the 4-way handshake, including generating and handling nonces (e.g., ANonce, SNonce), computing the PTK, and generating EAPOL M2 and M4 as needed.

In one embodiment, the device authorization component 1255 is configured to handle preparation and protection of an authorization ID for transmission to the AP as part of device-level access control. In one embodiment, the device authorization component 1255 may encrypt a per-device authorization ID using the KEK, either directly or after encapsulating the ID in a KDE. In one embodiment, the device authorization component 1255 may generate a hash of the provisioned authorization ID using a per-session authorization nonce (e.g., received from the AP) and transmit the hashed value within an encrypted KED. In one embodiment, the device authorization component 1255 may derive an authorization key by hashing a locally generated KEK with the provisioned authorization token, encrypt the authorization ID using the KEK, and generate an authorization ticket by encrypting the SNonce using the authorization key. These values may be included in EAPOL M2 for mutual verification.

In one embodiment, the session management and policy enforcement component 1260 is configured to apply group policies or access restrictions after completing the handshake, based on the authorization result received from the AP (e.g., full access, guest VLAN, or onboarding mode).

Although depicted as a discrete component for conceptual clarity, in some embodiments, the operations of the depicted components (and others not illustrated) may be combined or distributed across any number of components. Further, although depicted as software residing in memory 1210, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

What is claimed is:

1. A method, comprising:
authenticating, by a network device, a client device using simultaneous authentication of equals (SAE) with a shared passphrase;
after completing association, sending, by the network device to the client device, a first message comprising an access point (AP)-generated authorization random value;
receiving, by the network device from the client device, a second message comprising a station (STA)-generated authorization random value and an authorization identifier, wherein the authorization identifier is encrypted using a session key;
decrypting, by the network device, the authorization identifier using the session key;
determining, by the network device, whether the authorization identifier matches an entry in an authorization database;
in response to determining that the authorization identifier matches an entry in the authorization database, sending, by the network device, a third message confirming authorization of the client device as a trusted entity; and
receiving, by the network device from the client device, a fourth message confirming completion of a security key exchange.

2. The method of claim 1, wherein the session key comprises a key encrypting key (KEK), and the session key is computed using the shared passphrase, the AP-generated authorization random value, the STA-generated authorization random value, an address of the network device, and an address of the client device.

3. The method of claim 2, wherein the authorization identifier is encrypted directly using the KEK before being transmitted in the second message by the client device to the network device.

4. The method of claim 2, wherein the authorization identifier is included within a key data element (KDE), wherein the KDE is encrypted using the KEK before being transmitted in the second message by the client device to the network device.

5. The method of claim 1, wherein the network device comprises at least one of an AP, a radius server, or a wireless controller.

6. The method of claim 1, further comprising:
in response to determining that the authorization identifier does not match an entry in the authorization database, sending, by the network device, a deauthentication message indicating that the client device is not a trusted entity and denying access of the client device to a network managed by the network device.

7. A method, comprising:
authenticating, by a network device, a client device using simultaneous authentication of equals (SAE) with a shared passphrase;
after completing association, generating, by the network device, an AP-generated authorization random value;
sending, by the network device to the client device, a first message comprising an access point (AP)-generated authorization random value and the AP-generated authorization random value;
receiving, by the network device from the client device, a second message comprising a station (STA)-generated authorization random value and a STA-generated hashed authorization identifier;
decrypting, by the network device, the STA-generated hashed authorization identifier using a session key;
determining, by the network device, whether the STA-generated hashed authorization identifier matches an entry in a precomputed hash database associated with a plurality of authorization identifiers known by the network device;
in response to determining that the STA-generated hashed authorization identifier matches an entry in the precomputed hash database, sending, by the network device, a third message confirming authorization of the client device as a trusted entity; and
receiving, by the network device from the client device, a fourth message confirming completion of a security key exchange.

8. The method of claim 7, wherein the STA-generated hashed authorization identifier is computed by the client device by applying a hash function to an authorization identifier associated with the client device using the AP-generated authorization random value, and the STA-generated hashed authorization identifier is encrypted using the session key.

9. The method of claim 8, wherein the session key comprises a key encryption key (KEK), and the session key is computed using the shared passphrase, the AP-generated authorization random value, the STA-generated authorization random value, an address of the network device, and an address of the client device.

10. The method of claim 9, wherein the STA-generated hashed authorization identifier is included within a key data element (KDE), wherein the KDE is encrypted using the KEK before being transmitted in the second message by the client device to the network device.

11. The method of claim 7, further comprising:
in response to determining that the STA-generated hashed authorization identifier does not match an entry in the precomputed hash database, sending, by the network device, a deauthentication message indicating that the client device is not a trusted entity and denying access of the client device to a network managed by the network device.

12. The method of claim 7, further comprising:
precomputing, by the network device, a plurality of STA-generated hashed authorization identifiers by applying a hash function to the plurality of authorization identifiers known by the network device using the AP-generated authorization random value; and
storing, by the network device, the plurality of precomputed STA-generated hashed authorization identifiers in the precomputed hash database for verification.

13. A method, comprising:
authenticating, by a network device, a client device using simultaneous authentication of equals (SAE) with a shared passphrase;
sending, by the network device to the client device, a first message comprising a first access point (AP)-generated authorization random value;
receiving, by the network device from the client device, a second message comprising a first station (STA)-generated authorization random value, an authorization identifier, and an authorization ticket;
decrypting, by the network device, the authorization identifier using a session key;
retrieving, by the network device, an authorization token associated with the authorization identifier from a database;
computing, by the network device, an AP-authorization key by applying a hash function to the authorization token and the session key;
decrypting, by the network device, the authorization ticket using the AP-authorization key to extract a second STA-generated authorization random value;
determining, by the network device, whether the second STA-generated authorization random value matches the first STA-generated authorization random value included within the second message; and
in response to determining that the second STA-generated authorization random value matches the first STA-generated authorization random value, sending, by the network device, a third message comprising the first AP-generated authorization random value and a second authorization ticket, wherein the second authorization ticket is generated by encrypting the first AP-generated authorization random value using the AP-authorization key.

14. The method of claim 13, wherein the authorization identifier is encrypted using the session key, and the authorization ticket is generated by encrypting the first STA-generated authorization random value using a STA-authorization key.

15. The method of claim 13, further comprising:
in response to determining that the second STA-generated authorization random value does not match the first STA-generated authorization random value, sending, by the network device, a deauthentication message indicating the client device is not a trusted entity and denying access of the client device to a network managed by the network device.

16. The method of claim 14, wherein the client device, upon receiving the first message, computes the STA-authorization key by applying the hash function to the authorization token and the session key, wherein the authorization token is associated with the authorization identifier that are assigned to the client device.

17. The method of claim 16, wherein the client device, upon receiving the third message:
decrypt the second authorization ticket using the STA-authorization key;
extract a second AP-generated authorization random value from the authorization ticket; and
determine whether the second AP-generated authorization random value matches the first AP-generated authorization random value included within the second message.

18. The method of claim 17, wherein the client device, upon receiving the third message:
in response to determining that the second AP-generated authorization random value matches the first AP-generated authorization random value, send a fourth message to the network device indicating a successful verification of the authorization identifier.

19. The method of claim 17, wherein the client device, upon receiving the third message:
in response to determining that the second AP-generated authorization random value does not match the first AP-generated authorization random value, terminate a current connection with the AP.

20. The method of claim 19, wherein the client device sends a rejection message to the network device indicating a failure of verification of the authorization identifier.
